(19) United States
(12) Patent Application Publication
(10) Pub. No.: US 2026/0233427 A1
(43) Pub. Date: Aug. 13, 2026

(54) METHOD AND DEVICE FOR CUTTING A FOOD ITEM INTO SEVERAL SMALLER PIECES

(71) Applicant: Weber Food Technology SE & CO. KG, Breidenbach (DE)

(72) Inventors: Isabell Henseling, Bracht (DE); Franziska Rupp, Breidenbach (DE); Fabian Sassmannshausen, Steffenberg-Steinperf (DE); Florian Reitz, Breidenbach (DE); Christoph Kuhmichel, Bad Laasphe (DE); Frank Thiemar, Erfurt (DE); Bjoern Weiss, Weitefeld (DE)

(21) Appl. No.: 19/158,963

(22) PCT Filed: Feb. 23, 2024
(86) PCT No.: PCT/EP2024/054702

§ 371 Date: Oct. 6, 2025

(30) Foreign Application Priority Data
Feb. 24, 2023 (DE) 10 2023 104 643.8

(51) Int. Cl. B26D 7/06; B25J 11/00; B26D 1/553

(52) U.S. Cl. CPC B26D 7/0616; B25J 11/0045; B26D 1/553; B26D 2210/02

(57) ABSTRACT

Methods and apparatuses for cutting a piece of food into a plurality of smaller pieces are disclosed. The piece of food may be provided on a punch arranged below a cutting unit, which may be moved relative to the cutting unit and/or moved relative to the punch so that the piece of food is pressed from below through the cutting unit and the piece of food is thereby cut into a plurality of smaller pieces disposed next to one another. The plurality of smaller pieces may be lifted using a gripper. The piece of food can be pressed from above through the cutting unit.

### RELATED APPLICATION

The present application is a national stage application under 35 U.S.C. § 371 of International Application No. PCT/EP2024/054702, filed 23 Feb. 2024, which claims priority from German Patent Application No. 10 2023 104 643.8, filed 24 Feb. 2023. The above-referenced applications are incorporated by reference.

### SUMMARY

The invention relates to a method and an apparatus for cutting a piece of food into a plurality of smaller pieces. In particular, the invention relates to a method and an apparatus for cutting a cheese slice into a plurality of cheese cubes or into at least one cut-out shape and a remainder.

An apparatus is known from the prior art that is configured to produce cheese cubes from a cheese bar, i.e. a relatively large, cuboid piece of cheese. For this purpose, the cheese bar is first pressed through a cutting grid in a horizontal direction of movement and is thereby cut into at the end face. When the cut cheese bar has been pressed through the cutting grid far enough that a defined cube edge length of the cut cheese bar projects from the cutting grid at the rear side of the cutting grid, the cheese bar is cut into cubes by means of a blade moving in a vertical direction. This apparatus has the disadvantage that the cheese cubes are not present next to one another in an orderly manner, i.e. in a grid arrangement, but fall from the cheese bar in an unordered manner.

Furthermore, an apparatus is known to produce cheese cubes from a cheese slice that, as a rule, was cut off from a cheese bar by a slicer. The cheese slice is in this respect placed by hand onto a cutting grid and is then pressed by hand by means of a punch from above through a horizontally arranged cutting grid. The use of this apparatus has the advantage that the cheese cubes can be placed in an orderly manner, i.e. in a grid arrangement, on a package, for example on a tray, and can thus be presented in a visually appealing and space-saving manner in the package. However, the use of this apparatus has the disadvantage that the manual placement of the cheese slices and the manual production of the cheese cubes requires relatively long cycle times and produces high personnel costs.

It is an object of the present invention to provide a method and an apparatus that make it possible that the produced pieces, in particular cheese cubes, can be presented in a grid arrangement in a package and can nevertheless be produced quickly and without a high personnel expenditure. It is furthermore an object of the present invention to provide a method and an apparatus that make it possible to produce at least one shape that is cut out from at least one piece of food, for example a shape of a face, quickly and without a high personnel expenditure.

This object is satisfied by the subjects of the independent claims. The dependent claims define embodiments of the invention.

An inventive idea common to the independent claims is to provide a gripper to automate the cutting of pieces of food by means of a cutting unit, in particular the cutting of a cheese slice by means of a cutting grid to produce cheese cubes.

A gripper within the meaning of this application is a technical unit that is configured to hold or grip, lift, place or drop and release objects. The gripper can have a plurality of gripping elements that are movable relative to one another, preferably to grip the piece of food, a plurality of smaller pieces or a cut-out shape from the side. Alternatively thereto, the gripper can, for example, also be configured as a vacuum gripper. In this case, the piece of food, the plurality of smaller pieces or the cut-out shape can be held from above. The gripper can also comprise one or more claws to grip under the piece of food, the plurality of smaller pieces or the cut-out shape.

The gripper is preferably attached to a movement unit, for example a robot arm or a 3-axis positioning system, i.e. a delta robot. The gripper can be movable by means of the movement unit, preferably fully automatically, i.e. without a manual action. A possible gripping movement or another kind of activation of the gripper can also take fully automatically. More specifically, the gripper preferably grips the piece of food—as a whole or cut—automatically and preferably places the piece of food automatically. The gripper can therefore be fully controlled by a control device and can move according to a predefined program sequence.

Specifically, the object is inter alia satisfied by a method for cutting at least one piece of food, for example a cheese slice or a stack of cheese slices, into a plurality of smaller pieces, for example into a plurality of smaller cubes or into at least one cut-out shape and a remainder, said method comprising:
providing the piece of food on a support structure arranged below a cutting unit, for example a cutting grid or a cutting mold,
moving a punch relative to the support structure to lift the piece of food from the support structure,
moving the punch relative to the cutting unit and/or moving the cutting unit relative to the punch so that the piece of food is pressed from below through the cutting unit and the piece of food is thereby cut into smaller pieces, for example, a plurality of cubes disposed next to one another or at least one cut-out shape and a remainder,
lifting the plurality of smaller pieces or at least one of the smaller pieces by means of a gripper.

In this case, the gripper is therefore used to lift the plurality of smaller pieces produced by the cutting, which are usually present in a grid arrangement, or at least one of the smaller pieces from an upper side of the punch to and place them, for example, onto or into a package, such as a tray.

The above-mentioned method in which the piece of food, in particular the cheese slice, is pressed from below through the cutting grid, has a plurality of advantages: On the one hand, any imprints on the smaller pieces, which can, for example, be produced by the pressing by means of the punch, are not visible to the customer in the package since the imprints are present on the side facing the package, i.e. the side hidden from the customer. In addition—in comparison with a pressing of the piece of food from above through the cutting grid onto a package support—any crumbs that may occur depending on the type of food fall away downwardly on the cutting of the piece of food by means of the cutting grid or on the transport by means of the gripper so that fewer crumbs enter the package.

In general, it would also be conceivable to carry out the above-mentioned method without using a gripper. In this case, the plurality of smaller pieces or at least one of the pieces could, for example, be pushed down from the surface of the punch by means of a slider. This method without a gripper is likewise the subject of the present disclosure and can be combined with any feature described in this application that does not concern the gripper.

Advantageous embodiments of the invention can be seen from the dependent claims, from the description, and from the drawings.

According to one embodiment, the support structure is coupled or can be coupled to a mover of a transport system. The transport system preferably describes at least one closed transport path, i.e. a circular path along which the mover moves. The provision of the piece of food can comprise transporting the piece of food disposed on the support structure by means of the transport system under the cutting unit. The cutting unit can, for example, be configured as a cutting grid or as a cutting mold. This inter alia has the advantage that the piece of food can be provided in a simple but safe manner.

The transport system is preferably based on a so-called LSM drive, i.e. on a drive by linear synchronous motors. The at least one mover of the transport system can be equipped with at least one permanent magnet. In order to drive the at least one mover along the transport path, the transport path can be configured to generate a traveling electromagnetic field. Such a transport system or drive principle is, for example, also described in WO 2003/029651 A2 and WO 2010/085670 A1. Reference is herewith explicitly made to these documents with reference to the disclosure of a possible drive principle or functional principle for the invention.

According to one embodiment, the piece of food can be transported disposed on the support structure, which is coupled or can be coupled to a mover of a transport system, by means of the transport system into a position above the punch, i.e. over the punch. The punch can hereby lift the piece of food from the support structure by a, preferably exclusive, vertical movement.

To further reduce the cycle time for providing the piece of food, a plurality of support structures can be provided. A plurality of movers are preferably provided. At least one of the support structures can be coupled or couplable to one of the movers of the transport system in each case. In other words, each mover can hold at least one support structure or can receive a support structure. A plurality of pieces of food can then be provided in that the pieces of food are successively transported individually disposed on one of the support structures by the transport system under the cutting unit, for example the cutting grid or the cutting mold. Alternatively or additionally, the pieces of food can thus be successively transported individually disposed on one of the support structures by the transport system over the punch.

According to one embodiment, the moving of the punch relative to the support structure to lift the piece of food from the support structure comprises an engagement of the punch into at least one recess of the support structure. In order to ensure a secure position of the piece of food on the support structure and the punch, it is advantageous if the support structure has a plurality of recesses into which the punch can engage in order to lift the piece of food from the support structure. The recesses are preferably slot-shaped and/or arranged parallel to one another.

According to one embodiment, a plurality of support structures can be couplable to one mover. For example, two or four support structures, i.e. spaces for a slice or a portion, can be couplable to a mover. The throughput can hereby be increased. The support structures can be formed in one piece with one another.

According to a first alternative embodiment, the lifting of the plurality of smaller pieces or of the at least one of the smaller pieces is carried out by means of a mechanical gripper. In this respect, the plurality of smaller pieces are jointly held by the gripper in that the gripper grips the smaller pieces together from two oppositely disposed directions, in particular lateral directions. For this purpose, the gripper preferably has two gripping elements that are movable relative to one another. The mechanical gripper can be pneumatically or electrically driven, for example. In other words, the gripping elements can be drivable by means of pneumatics or by means of an electric motor in order to perform a gripping movement. This alternative is suitable, for example, for cheese with holes or other food products that cannot be reliably lifted by means of vacuum grippers.

According to a further alternative embodiment, the lifting of the plurality of smaller pieces or of the at least one of the smaller pieces can be carried out by means of a vacuum gripper. Preferably, each of the plurality of smaller pieces can in this respect be lifted by means of exactly one suction element of the vacuum gripper. For this purpose, exactly one suction element can be provided for each section of the cutting unit, in particular of the cutting grid or the cutting mold.

In order to create a distance of the smaller pieces from one another, the suction elements can be movable relative to one another. The plurality of smaller pieces can hereby be placed spaced apart from one another into a package in a simple and reliable manner and can thus better give the customer the impression that there are a plurality of smaller pieces in the package.

Alternatively thereto, the pieces can already be spaced slightly apart from one another during the production by a, for example, convex or slanted punch surface. Said pieces can be picked up and placed separately, i.e. spaced apart from one another, by a vacuum gripper.

In general, the gripper can place or drop the plurality of smaller pieces or the at least one of the smaller pieces onto or into a package, in particular insert them into a package, for example a tray or a, for example, deep-drawn film, or drop them into a package. Inserting here means that the plurality of smaller pieces or the at least one of the smaller pieces already touch the package before the gripper releases the plurality of smaller pieces or the at least one of the smaller pieces. In contrast, dropping means that the plurality of smaller pieces or the at least one of the smaller pieces do not yet touch the package when the gripper releases the plurality of smaller pieces or the at least one of the smaller pieces, and thus the plurality of smaller pieces or the at least one of the smaller pieces fall at least a short distance onto the package.

The smaller pieces or the at least one of the smaller pieces can be dropped in an orderly manner, i.e. in a grid arrangement. Alternatively thereto, the smaller pieces can be dropped in an unordered manner, i.e. without adopting a grid arrangement. For example, the smaller pieces can be dropped from a height that causes the grid arrangement to disintegrate during the falling and/or as a result of the impact on an impact surface.

Alternatively or additionally, devices could be provided that serve to break up the grid arrangement. For example, the gripper could comprise a punch or an ejector that, on the dropping by the gripper, presses on the smaller pieces from above in order to break up the grid arrangement. The punch or ejector can be equipped with an uneven abutment surface, for example, a rounded abutment surface or a wedge-shaped abutment surface. The grid arrangement of the smaller pieces is hereby easily broken up.

Alternatively or additionally thereto, the devices for breaking up the grid arrangement can comprise a slanted impact surface, i.e. neither a horizontal nor a vertical impact surface, for example in the form of a funnel. Such a slanted impact surface can serve to break up an arrangement of the smaller pieces and to guide the smaller pieces.

Furthermore, such a slanted impact surface, in particular in the form of a funnel, can serve to bring together the smaller pieces on a smaller base area if they are to be distributed over a larger area, for example due to a large drop height.

Alternatively or additionally, the devices for breaking up the grid arrangement can comprise at least one deflection element that is configured to break up the grid arrangement of the smaller pieces in flight in that at least some of the smaller pieces impact the deflection element during the falling. The at least one deflection element can, for example, be configured as a grid or as a single rod, as a wedge-shaped or cone-shaped element, as a driven shaft similar to a folding shaft at the slicer (cylindrical or wedge-shaped) or as a combination of these elements.

According to one embodiment, a scraping device can be provided. The scraping device can scrape off at least a partial quantity of the plurality of smaller pieces from the cutting unit. The scraping device can comprise a scraping element that can be moved along the cutting unit. Preferably, the scraping device comprises at least one spring element that is coupled to the scraping element in order to generate the movement of the scraping element. The at least one spring element can be preloaded during the cutting of the piece of food and can relax again during the scraping off of a smaller piece from the cutting unit. Preferably, the at least one spring element is preloaded in that the punch presses at least one of the smaller pieces against the scraping element while the punch presses the piece of food through the cutting unit. Preferably, the spring element and the scraping element coupled to the spring element press this at least one of the smaller pieces against the cutting direction when the piece of food is completely cut into the plurality of smaller pieces so that the at least one of the smaller pieces is scraped off from the cutting unit. The scraping device is particularly useful if the cutting unit has one or more blades or cutting blades since in particular soft food products can easily adhere to their surfaces.

According to one embodiment, the punch is attached in a stationary manner to a machine frame. In other words, the punch itself is indeed movable, in particular in a vertical direction, but is not attached to a movable element such as a mover. During the movement of the punch relative to the support structure, the punch can be moved exclusively in the cutting direction and against the cutting direction, preferably exclusively in a vertical direction.

The object is inter alia also satisfied by a method for cutting a piece of food, for example a cheese slice, into a plurality of smaller pieces, for example into a plurality of smaller cubes or into at least one cut-out shape and a remainder, said method comprising:
placing or dropping the piece of food by means of a gripper onto an upper side of a cutting unit, in particular a cutting grid or a cutting mold, or an upper side of a structure movable by the cutting unit, and
moving a punch relative to the cutting unit and/or moving the cutting unit relative to the punch so that the piece of food is pressed from above through the cutting unit and the piece of food is thereby cut into a plurality of smaller pieces that are in particular disposed next to one another.

In this variant, the gripper is therefore used to pick up the piece of food, for example a cheese slice, and to place it either directly onto the cutting grid or onto an upper side of a structure that can be moved by the cutting grid. Time and labor costs can hereby be saved compared to a manual placing of the piece of food.

This variant inter alia has the advantage that a weight force of the punch supports the movement of the punch to press the piece of food from above through the cutting grid. Compared to the variant in which the piece of food is pressed through the cutting grid from bottom to top, a drive for the punch with lower power can hereby be installed.

The placing of the piece of food can be carried out by means of a mechanical gripper or by means of a vacuum gripper.

The punch can be arranged in a fixed or stationary manner when the cutting grid is moved relative to the punch. Alternatively thereto, the punch can be movably attached to a machine frame, in particular exclusively, in the cutting direction and against the cutting direction, for example, if the cutting grid is fixedly fastened to the machine frame. The cutting direction preferably extends along a straight line.

According to a further alternative, the punch can be attached to a robot arm, in particular a robot arm moving the gripper. If a torque to be regularly applied by the robot arm is not sufficient to press the piece of food through the cutting grid by means of the punch arranged at the robot arm, a stationary support surface or a coupling point can be provided at/to which the robot arm can be supported or coupled in order to increase the effective torque on the punch. In this respect, a punch, which can, for example, be pneumatically driven, can be provided next to or at the gripper at the robot arm.

The robot can in particular be a delta robot or a so-called pick robot.

According to one embodiment, the gripper can function as a punch. For example, the gripper can be configured as a vacuum gripper and can furthermore serve to press the piece of food through the cutting grid.

Preferably, the methods described above are used to cut a food slice, in particular a cheese slice, cut off from a food bar by means of a slicer, into a plurality of smaller pieces, in particular cube-shaped pieces or into at least one cut-out shape and a remainder. For example, the food slice can have a width of between 10 mm and 30 mm. Thus, food cubes can, for example, be produced that have an edge length of between 10 mm and 30 mm. Alternatively thereto, a food slice, in particular a cheese slice, can be produced with a shape, for example a shape of a face such as a bear's face, that has a thickness of between 10 mm and 30 mm. It would furthermore be conceivable to cut a plurality of food slices disposed above one another, which are usually referred to as a portion, into a plurality of smaller pieces, for example into at least one shape and a remainder, using the cutting unit.

In order to use the gripper as efficiently as possible, a plurality of cutting units can be provided per gripper. Per gripper preferably means per gripper cell or robot cell. The gripper cell or robot cell can be defined by a barrier, for example an acrylic glass enclosure, or its number of independent robot arms.

The method can then comprise the following steps:
moving a first punch relative to a first cutting unit and/or moving the first cutting unit relative to the first punch to cut a first piece of food into first smaller pieces
and parallel thereto
moving a second punch relative to a second cutting unit and/or moving the second cutting unit relative to the second punch to cut a second piece of food into second smaller pieces.

In other words, two pieces of food can be cut into smaller pieces at the same time, in at least partly overlapping time intervals, by respective different cutting units. The cutting of the pieces of food can in this respect be started and finished offset in time from one another or at the same time. These first and second smaller pieces can then, for example, be successively lifted by the one gripper. Alternatively thereto, the one gripper can place two pieces of food simultaneously or successively onto the first cutting unit and the second cutting unit or onto first and second structures that can be moved by the cutting unit. The output per gripper can hereby be increased.

According to one embodiment, the plurality of cutting units can be moved along a circular path. The cutting units can move sectionally synchronously with the movers in a conveying direction. The cutting units can divide the respective piece of food into the plurality of smaller pieces, while the corresponding mover comprising the support structure, the punch, the corresponding cutting unit and the piece of food disposed on the support structure move synchronously with one another in the conveying direction. Alternatively thereto, the cutting units and corresponding punches can move in a section synchronously with the packages and the corresponding punch can press the piece of food from above through the cutting unit, while the cutting unit, the punch, the piece of food and the package move in the conveying direction. Generally speaking, the cutting units can move along a circular path, wherein one part of the circular path extends parallel to a transport path for the pieces of food.

According to a variant that can be implemented with a simpler design, the cutting units do not move with the pieces of food, but are fixedly arranged or only move perpendicular to the conveying direction, for example, in the cutting direction and against the cutting direction.

The object is also satisfied by an apparatus for cutting at least one piece of food into a plurality of smaller pieces, in particular into a plurality of smaller cubes or into at least one cut-out shape and a remainder, said apparatus comprising:
at least one cutting unit, in particular a cutting grid or a cutting mold,
at least one punch to press the piece of food through the cutting unit, and
at least one gripper, wherein the gripper can be moved into a region above the cutting unit to place the piece of food on the upper side of the cutting unit or a support surface movable by the cutting unit or to pick up the plurality of smaller pieces or at least one of the smaller pieces from the upper side of the cutting unit or a support surface movable by the cutting unit.

The apparatus can be configured in two ways. Either the punch presses the piece of food through the cutting unit from bottom to top. In this case, the gripper can serve to pick up, i.e. to lift, the plurality of smaller pieces or at least one of the smaller pieces, for example from the upper side of the punch. Or the punch presses the food through the cutting unit from top to bottom. In this case, the gripper serves to place the piece of food directly on the cutting unit or on a support surface, which can be moved away downwardly by the cutting unit, before the cutting.

Both alternatives have in common that a gripper is provided to handle the food product. It is hereby possible to cut food slices in a fully automated manner into smaller pieces such that the outer shape of the food slice is retained, i.e. the smaller pieces produced from the food slice remain in their grid arrangement. With the apparatus, it is also possible to cut out shapes, such as a face shape, from a piece of food or from a stack of food slices.

According to one embodiment, the cutting unit comprises at least one cutting grid. Alternatively or additionally, the cutting unit comprises at least one cutting mold. The cutting grid in which the cutting edges intersect is well suited for producing smaller food cubes such as cheese cubes. The cutting mold in which the cutting edges preferably do not intersect is suitable for cutting out shapes, such as a face shape, from a piece of food or from a stack of food slices.

According to one embodiment, the support surface is a surface, in particular an end face, of the punch.

According to one embodiment, the gripper is configured as a mechanical gripper and/or as a vacuum gripper. The gripper can be configured as described above or below. The gripper can be coupled to a movement unit, i.e., for example, to a robot arm or a 3-axis positioning system. The gripper can preferably be moved into the region above the cutting grid by means of the movement unit.

The gripper can have a release aid to be able to remove adhering food from the gripper. For example, the gripper can have, at at least one holding surface, at least one outlet opening that can be flowed through by gas in order to release a food adhering to the holding surface from the holding surface by means of compressed air or gas. Alternatively or additionally, the gripper can comprise at least one release punch that can be moved out of a holding surface of the gripper in order to release a food adhering to the holding surface from the holding surface.

According to one embodiment, the apparatus, in particular the gripper, comprises a scraping device. The scraping device serves to scrape off at least a partial quantity of the plurality of smaller pieces from the cutting unit.

According to one embodiment, the cutting unit defines a plurality of substantially horizontally arranged cutting edges during operation. The punch can be movable substantially perpendicular to the cutting edges, i.e. movable in a perpendicular manner in the present case. The punch can be supported such that it can be moved from bottom to top and from top to bottom. Alternatively or additionally, a plurality of the cutting edges can be arranged slanted to the horizontal. If the punch is moved perpendicular to the horizontal, a required cutting force can be reduced by the slanted arrangement of the cutting edges since the piece of food is first partly cut. It would generally also be conceivable to orient the cutting edges slanted to the horizontal and to move the punch perpendicular to the cutting edges.

According to one embodiment, the punch has a punch surface, wherein grooves corresponding to the cutting unit are provided in the punch surface. The grooves are designed so that the cutting unit dips into the grooves when the piece of food has been pressed through the cutting unit, and the cutting unit thus does not collide with the punch.

The punch surface preferably forms a plurality of partial punch surfaces surrounded by the grooves. At least some of the partial punch surfaces, in particular all the partial punch surfaces, can have a corner-free, in particular circular, periphery. In other words, peripheral surfaces of sections of the punch defining partial punch surfaces can be designed without edges. The grooves of the at least one punch can hereby be cleaned more easily.

To make the punch lighter, at least some of the partial punches can be hollow. However, the partial punches can still have a full-surface, i.e. closed, partial punch surface. According to a light and particularly easy-to-clean variant, the partial punches can comprise a partial punch plate, in particular a full-surface partial punch plate, that is held in position by a plurality of limbs. In general, lateral openings can be provided that connect the environment of the partial punches with a respective inner space of the partial punches.

According to one embodiment, the punch has a drive. In other words, the punch is coupled or can be coupled to a drive in order to move the punch in the cutting direction, in particular in a vertical direction. The drive is preferably configured to press the piece of food independently through the cutting grid. The punch is preferably fixedly connected to a part of the drive so that a movement of the punch in the cutting direction and against the cutting direction can be effected by the drive.

The drive of the punch can be configured as a servomotor or a pneumatic drive. In this respect, the servomotor has the advantage that the speed of the punch can be varied/controlled via the cutting process in order, for example, to initially move the punch more slowly during a cutting and to then accelerate the punch again.

The drive of the punch can be fastened in a stationary manner to an apparatus frame or to the at least one mover.

Preferably, the punch and the drive are arranged together in a stationary manner. In this case, the punch can be configured to be moved relative to a support structure in order to lift the piece of food from the support structure and to press it through the cutting unit.

Alternatively thereto, only the drive can be arranged in a stationary manner, but the punch can be arranged at the mover. In order to reliably couple a stationary drive and a punch moving along a transport path during operation, centering devices can be provided that perform a centering of the punch relative to the drive on a coupling of the drive, in particular a drive element, such as a cylinder, to the punch. For example, at each punch, at least one centering device, e.g. a conical pin, can be provided that engages into a centering device, e.g. a bore, at the drive element. Alternatively thereto, at each punch, at least one centering device, e.g. a conical bore, can be provided, into which a centering device, e.g. a conical pin, engages at the drive element. Two centering devices are preferably provided at the punch and interact with two corresponding centering devices at the drive element. A rotational misalignment of the punch relative to the drive can hereby also be corrected. The skilled person will recognize that different kinds of centering devices are conceivable.

In order to reduce a maximum required feed force for the punch, it is advantageous if the cutting unit has a plurality of cutting edges arranged spaced apart from one another in the direction of movement of the punch. In other words, the cutting edges can be arranged on different planes so that the piece of food first comes into contact with a first group of cutting edges and only then comes into contact with a second group of cutting edges when the first group of cutting edges has already dipped into the piece of food. Preferably, the cutting unit, in particular the cutting grid, has longitudinal cutting edges and transverse cutting edges. In other words, the cutting grid has first cutting edges and second cutting edges oriented transversely, in particular perpendicular, to the first cutting edges. For example, the longitudinal cutting edges can be arranged on one plane and the transverse cutting edges on another plane. According to one embodiment, the longitudinal cutting edges can be arranged on different planes. Alternatively or additionally, the transverse cutting edges can be arranged on different planes.

According to one embodiment, the cutting grid is configured as a wire grid having a plurality of wires. In other words, the cutting edges of the cutting grid are preferably formed by wires. The use of wires inter alia has the advantage that a cutting resistance and thus the maximum required feed force for the punch are reduced. To further reduce the maximum required feed force for the punch, at least some of the wires of the wire grid can be arranged spaced apart from one another in the direction of movement of the punch. Preferably, the cutting grid has longitudinal cutting wires and transverse cutting wires. For example, the longitudinal cutting wires can be arranged on one plane and the transverse cutting wires on another plane. According to one embodiment, the longitudinal cutting wires can be arranged below one another on different planes. Alternatively or additionally, the transverse cutting wires can be arranged below one another on different planes.

According to an alternative embodiment, the cutting unit, in particular the cutting grid or the cutting mold, is formed by blades. Blades within the meaning of this application are cutting elements that, when used as intended, can at most be bent slightly in the cutting direction by the contact with the piece of food. For this purpose, the blades can have an extent in the cutting direction that is a multiple of a width of the blade. To minimize friction, the blades can be subjected to vibrations in the ultrasonic range. The apparatus can comprise an oscillation generator for this purpose. If the cutting unit is configured as a cutting mold, it is advantageous to form the cutting mold from blades since it is easier to present curved cutting edges using blades.

According to one embodiment, the wires of the cutting grid are each fastened to two suspensions arranged spaced apart from one another. In order to reduce the maximum required feed force for the punch, one of the suspensions, in particular at least one suspension per wire, can be designed as flexible.

According to one embodiment, a pneumatic element or a hydraulic element is provided that effects a flexibility of the at least one suspension. Alternatively, a spring element can be provided that effects the flexibility of the suspension. For a detailed description of how the wires of the cutting grid can be made flexible, reference is made to the German patent application DE 10 2019 108 452. In order to save installation space, two wires of the cutting grid, in particular two wires of the cutting grid arranged parallel to one another and directly next to one another, can be coupled to the same pneumatic element, hydraulic element or spring element so that a movement of the pneumatic element, hydraulic element or spring element allows a curvatures of the two wires. Preferably, the two wires are coupled to a common suspension that is designed as flexible by a pneumatic element, hydraulic element or spring element. The suspension can be pivotable to compensate for differences between tensile stresses of the two wires.

According to one embodiment, all the wires of the wire grid are each fastened to two suspensions arranged spaced apart from one another. The suspensions of the wires of the wire grid can be connected to one another via a frame.

The cutting frame can be removable from the rest of the apparatus and/or can be fastenable to the rest of the apparatus. Preferably, the cutting frame can be removable from the rest of the apparatus and/or fastenable to the rest of the apparatus without tools, i.e. without having to use tools.

In order, for example, to be able to move the frame into an inactive position, for example to process other foods using the apparatus or to clean the frame, the frame can be pivotably arranged at a machine frame about a defined pivot axis. For example, the frame can be arranged in a receiver that is pivotably arranged at the machine frame relative to the machine frame. The pivot axis can be vertically or horizontally arranged in operation.

According to one embodiment, the frame has grooves in which the wires lie. The grooves are preferably adapted to the wires in terms of their width so that they represent a lateral guidance for the wires. A lateral movement of the wires can hereby be reduced and the cutting precision can be increased.

According to one embodiment, at least one of the wires of the wire grid is clamped between the suspensions under tensile stress. A force measurement device can be provided to measure the tensile stress acting on the wire. Alternatively or additionally, force control devices can be provided to control a return force acting on the wire. Force regulating devices could also be provided to regulate the return force acting on the wire.

According to one embodiment, devices for recognizing damage to the wire grid are provided. The devices for recognizing damage to the wire grid can be configured and set up to detect a tearing of one of the wires. For example, a sensor can be provided that detects a pressure increase or a pressure drop in a pneumatic or hydraulic chamber in order to recognize damage to the wire grid therefrom. The pressure increase or pressure drop measured by the sensor can also be used to recognize how long the cutting process will take or when the cutting process will be completed. For example, cutting times of different lengths can occur due to different types of food, different external conditions such as temperature and humidity, and/or different properties of the wires. In order to dynamically adapt the temporally subsequent process steps to the cutting times, the pressure measured by the sensor can be evaluated and, from certain threshold values, for example a drop in pressure above a certain threshold value, a subsequent process step, such as a picker moving off, e.g. to place a new piece of food or pick up cut pieces of food, a mover moving off, etc., can be initiated.

The pressure increase or pressure drop measured by the sensor can also be used to recognize which type of food product, for example which type of cheese, is currently being processed, provided that a consistency of the food products to be differentiated have a sufficiently large deviation from one another.

According to an alternative embodiment, the cutting unit is configured as at least one cutting mold comprising at least one cutting blade. The cutting mold can comprise a plurality of cutting blades. For example, two substantially circular cutting blades can be provided that cut out the eyes of a face from the piece of food. In addition, a mouth-shaped cutting blade can be provided that cuts a mouth of a face out of the piece of food. In general, the cutting blades of the cutting mold can be curved and/or can have a closed peripheral shape.

According to one embodiment, the cutting blades can have intersecting cutting edges or non-intersecting cutting edges, for example in a face shape.

According to one embodiment, the support structure is coupled or can be coupled to a mover of a transport system. The transport system can be configured to transport the piece of food disposed on the support structure under the cutting unit and/or over the punch. Preferably, the punch can be moved in a vertical direction relative to the support structure in order to lift the piece of food from the support structure and to press it through the cutting unit. In this embodiment, the support structure can be manufactured particularly cost-effectively and the transport system can thus also be manufactured particularly cost-effectively.

According to one embodiment, the support structure comprises at least one recess. The support structure preferably comprises a plurality of recesses. The at least one recess can be designed so that the punch engages through it in order to lift the piece of food from the support structure and to press it through the cutting unit. The at least one recess can be designed as an elongate recess, in particular a rectangular recess. If a plurality of recesses are formed in the support structure, they can be designed as rectangular recesses aligned parallel to one another.

According to one embodiment, a plurality of support structures and a plurality of movers are provided. At least one of the support structures can be coupled or couplable to one of the movers of the transport system in each case. For example, each mover can be equipped with one support structure, exactly two support structures or exactly four support structures. The support structure or the support structures can be fixedly connected to the respective mover. The transport system is preferably configured to successively transport the pieces of food, individually disposed on one of the support structures, under the cutting unit and/or over the punch.

According to one embodiment, the apparatus is configured to cut a plurality of pieces of food at the same time in that a first piece of food is pressed through a first cutting unit by means of a first punch, while a second piece of food is pressed through a second cutting unit by means of a second punch. The throughput of the apparatus can hereby be increased. The gripper can be configured to place the first and the second piece of food on the respective cutting unit, i.e. the first and the second cutting unit. The gripper can also be configured to place the first and the second piece of food on a respective support surface movable by the respective cutting unit. This support surface can be configured like a punch surface and can move back against the cutting direction on a cutting by the cutting unit. Alternatively thereto, the gripper can be configured to lift first smaller pieces cut from the first piece of food or at least one of the smaller pieces and second smaller pieces cut from the second piece of food or at least one of the second smaller pieces. For example, the gripper can be configured to successively lift the first smaller pieces or at least one of the first smaller pieces and the second smaller pieces or at least one of the second smaller pieces.

The first piece of food and the second piece of food can each rest on a separate punch while they are pressed from below through the cutting unit. Alternatively thereto, the first piece of food and the second piece of food can each rest on a separate cutting unit or a separate structure that can be moved by the cutting unit, and can be acted upon from above by the respective punch.

The apparatus preferably comprises an alignment unit to align the piece of food to be cut to match the alignment of the cutting unit. The alignment unit can be arranged in front of the cutting unit, viewed in the transport direction. Alternatively thereto, the alignment unit can be integrated into the cutting frame.

According to one embodiment, the alignment unit comprises two substantially L-shaped alignment elements that are movable along a diagonal towards the piece of food. A respective limb of each alignment element can hereby come into contact with a side surface of the piece of food and can thus align the piece of food. In order to avoid a deformation of the corner edges in the case of pieces of food with pointed corner edges, the alignment elements can have a recess in a transition region between the limbs so that the corner edges of the pieces of food do not come into contact with the respective alignment element.

The alignment unit can be controlled such that the alignment unit performs an alignment movement for each piece of food, i.e. regardless of whether the piece of food is already correctly aligned or not. Alternatively thereto, a detection device, e.g. a camera, can detect an alignment of the respective piece of food and the alignment unit can only be activated if the piece of food is oriented in a slanted manner such that a correction of the alignment of the piece of food is necessary. Preferably, a threshold value for a permissible deviation of the alignment of the piece of food can be set at the apparatus.

According to one embodiment, the cutting unit comprises a cutting mold for an outer contour and one or more cutting molds for inner contours. The one or more cutting molds for inner contours can be arranged at the gripper and can move with the gripper. Preferably, the at least one cutting mold for inner contours is configured to hold the at least one smaller piece in place while the smaller piece is moved by the gripper.

The invention furthermore relates to a food processing line comprising an apparatus as described above or below and a slicer, a sorting and conveying line and/or a packaging machine.

The object is inter alia also satisfied by a method for cutting a piece of food, in particular a cheese slice, into a plurality of smaller pieces, in particular into a plurality of smaller cubes, said method comprising:
providing the piece of food on a punch arranged below a cutting grid,
moving the punch relative to the cutting grid and/or moving the cutting grid relative to the punch so that the piece of food is pressed from below through the cutting grid and the piece of food is thereby cut into a plurality of smaller pieces disposed next to one another,
lifting the plurality of smaller pieces by means of a gripper.

In this case, the gripper is therefore used to lift the plurality of smaller pieces produced by the cutting, which are usually present in a grid arrangement, from an upper side of the punch to and place them, for example, onto or into a package, such as a tray.

The above-mentioned method in which the piece of food, in particular the cheese slice, is pressed from below through the cutting grid, has a plurality of advantages: On the one hand, any imprints on the smaller pieces, which can, for example, be produced by the pressing by means of the punch, are not visible to the customer in the package since the imprints are present on the side facing the package, i.e. the side hidden from the customer. In addition—in comparison with a pressing of the piece of food from above through the cutting grid onto a package support—any crumbs that may occur depending on the type of food fall away downwardly on the cutting of the piece of food by means of the cutting grid or on the transport by means of the gripper so that fewer crumbs enter the package.

In general, it would also be conceivable to carry out the above-mentioned method without using a gripper. In this case, the plurality of smaller pieces could, for example, be pushed down from the surface of the punch by means of a slider. This method without a gripper is likewise the subject of the present disclosure and can be combined with any feature described in this application that does not concern the gripper.

Advantageous embodiments of the invention can be seen from the dependent claims, from the description, and from the drawings.

According to one embodiment, the punch is coupled or can be coupled to a mover of a transport system. The transport system preferably describes at least one closed transport path, i.e. a circular path along which the mover moves. The provision of the piece of food can comprise transporting the piece of food disposed on the punch by means of the transport system under the cutting grid. This inter alia has the advantage that the piece of food can be provided in a simple but safe manner.

The transport system is preferably based on a so-called LSM drive, i.e. on a drive by linear synchronous motors. The at least one mover of the transport system can be equipped with at least one permanent magnet. In order to drive the at least one mover along the transport path, the transport path can be configured to generate a traveling electromagnetic field. Such a transport system or drive principle is, for example, also described in WO 2003/029651 A2 and WO 2010/085670 A1. Reference is herewith explicitly made to these documents with reference to the disclosure of a possible drive principle or functional principle for the invention.

To further reduce the cycle time for providing the piece of food, a plurality of punches can be provided. A plurality of movers are preferably provided. At least one of the punches can be coupled or couplable to one of the movers of the transport system in each case. In other words, each mover can receive at least one punch. A plurality of pieces of food can then be provided in that the pieces of food are successively transported individually disposed on one of the punches by the transport system under the cutting grid.

According to one embodiment, a plurality of punches can be couplable to one mover. For example, two punches can be couplable to one mover.

According to a first alternative embodiment, the lifting of the plurality of smaller pieces is carried out by means of a mechanical gripper. In this respect, the plurality of smaller pieces are jointly held by the gripper in that the gripper grips the smaller pieces together from two oppositely disposed directions, in particular lateral directions. For this purpose, the gripper preferably has two gripping elements that are movable relative to one another. The mechanical gripper can be pneumatically or electrically driven, for example. In other words, the gripping elements can be drivable by means of pneumatics or by means of an electric motor in order to perform a gripping movement. This alternative is suitable, for example, for cheese with holes or other food products that cannot be reliably lifted by means of vacuum grippers.

According to a further alternative embodiment, the lifting of the plurality of smaller pieces can be carried out by means of a vacuum gripper. Preferably, each of the plurality of smaller pieces can in this respect be lifted by means of exactly one suction element of the vacuum gripper. For this purpose, exactly one suction element can be provided for each section of the cutting grid.

In order to create a distance of the smaller pieces from one another, the suction elements can be movable relative to one another. The plurality of smaller pieces can hereby be placed spaced apart from one another into a package in a simple and reliable manner and can thus better give the customer the impression that there are a plurality of smaller pieces in the package.

Alternatively thereto, the pieces can already be spaced slightly apart from one another during the production by a, for example, convex or slanted punch surface. Said pieces can be picked up and placed separately, i.e. spaced apart from one another, by a vacuum gripper.

In general, the gripper can place or drop the plurality of smaller pieces onto a package, in particular insert them into a package, for example a tray or a, for example, deep-drawn film, or drop them into a package. Inserting here means that the plurality of smaller pieces already touch the package before the gripper releases the plurality of smaller pieces. In contrast, dropping means that the plurality of smaller pieces do not yet touch the package when the gripper releases the plurality of smaller pieces, and thus the plurality of smaller pieces fall at least a short distance onto the package.

The smaller pieces can be dropped in an orderly manner, i.e. in a grid arrangement. Alternatively thereto, the smaller pieces can be dropped in an unordered manner, i.e. without adopting a grid arrangement. For example, the smaller pieces can be dropped from a height that causes the grid arrangement to disintegrate during the falling and/or as a result of the impact on an impact surface.

Alternatively or additionally, devices could be provided that serve to break up the grid arrangement. For example, the gripper could comprise a punch or an ejector that, on the dropping by the gripper, presses on the smaller pieces from above in order to break up the grid arrangement. The punch or ejector can be equipped with an uneven abutment surface, for example, a rounded abutment surface or a wedge-shaped abutment surface. The grid arrangement of the smaller pieces is hereby easily broken up.

Alternatively or additionally thereto, the devices for breaking up the grid arrangement can comprise a slanted impact surface, i.e. neither a horizontal nor a vertical impact surface, for example in the form of a funnel. Such a slanted impact surface can serve to break up an arrangement of the smaller pieces and to guide the smaller pieces.

Furthermore, such a slanted impact surface, in particular in the form of a funnel, can serve to bring together the smaller pieces on a smaller base area if they are to be distributed over a larger area, for example due to a large drop height.

Alternatively or additionally, the devices for breaking up the grid arrangement can comprise at least one deflection element that is configured to break up the grid arrangement of the smaller pieces in flight in that at least some of the smaller pieces impact the deflection element during the falling. The at least one deflection element can, for example, be configured as a grid or as a single rod, as a wedge-shaped or cone-shaped element, as a driven shaft similar to a folding shaft at the slicer (cylindrical or wedge-shaped) or from a combination of these elements.

The object is inter alia also satisfied by a method for cutting a piece of food, in particular a cheese slice, into a plurality of smaller pieces, in particular into a plurality of smaller cubes, said method comprising:
placing the piece of food by means of a gripper onto an upper side of a cutting grid or an upper side of a structure movable by the cutting grid, and
moving a punch relative to the cutting grid and/or moving the cutting grid relative to the punch so that the piece of food is pressed from above through the cutting grid and the piece of food is thereby cut into a plurality of smaller pieces disposed next to one another.

In this variant, the gripper is therefore used to pick up the piece of food, for example a cheese slice, and to place it either directly onto the cutting grid or onto an upper side of a structure that can be moved by the cutting grid. Time and labor costs can hereby be saved compared to a manual placing of the piece of food.

This variant inter alia has the advantage that a weight force of the punch supports the movement of the punch to press the piece of food from above through the cutting grid. Compared to the variant in which the piece of food is pressed through the cutting grid from bottom to top, a drive for the punch with lower power can hereby be installed.

The placing of the piece of food can be carried out by means of a mechanical gripper or by means of a vacuum gripper. The punch can be arranged in a stationary manner when the cutting grid is moved relative to the punch. Alternatively thereto, the punch can be movably attached to a machine frame, in particular exclusively, in the cutting direction and against the cutting direction, for example, if the cutting grid is fixedly fastened to the machine frame. The cutting direction preferably extends along a straight line. According to a further alternative, the punch can be attached to a robot arm, in particular a robot arm moving the gripper. If a torque to be regularly applied by the robot arm is not sufficient to press the piece of food through the cutting grid by means of the punch arranged at the robot arm, a stationary support surface can be provided at which the robot arm can be supported in order to increase the effective torque on the punch.

According to one embodiment, the gripper can function as a punch. For example, the gripper can be configured as a vacuum gripper and can furthermore serve to press the piece of food through the cutting grid.

Preferably, the methods described above are used to cut a food slice, in particular a cheese slice, cut off from a food bar by means of a slicer, into a plurality of smaller pieces, in particular cube-shaped pieces. For example, the food slice can have a width of between 10 mm and 30 mm. Thus, food cubes can, for example, be produced that have an edge length of between 10 mm and 30 mm.

In order to use the gripper as efficiently as possible, a plurality of cutting grids can be provided per gripper. Per gripper preferably means per gripper cell or robot cell. The gripper cell or robot cell can be defined by a barrier, for example an acrylic glass enclosure.

The method can then comprise the following steps:
moving a first punch relative to a first cutting grid and/or moving the first cutting grid relative to the first punch to cut a first piece of food into first smaller pieces,
and parallel thereto
moving a second punch relative to a second cutting grid and/or moving the second cutting grid relative to the second punch to cut a second piece of food into second smaller pieces.

In other words, two pieces of food can be cut into smaller pieces at the same time, in overlapping time intervals, by respective different cutting grids. The cutting of the pieces of food can in this respect be started and finished offset in time from one another or at the same time. These first and second smaller pieces can then, for example, be successively lifted by the one gripper. Alternatively thereto, the one gripper can place two pieces of food successively onto the first cutting grid and the second cutting grid or onto first and second structures that can be moved by the cutting grids. The output per gripper can hereby be increased.

According to one embodiment, the plurality of cutting grids can be moved along a circular path. The cutting grids can move sectionally synchronously with the movers in a conveying direction. The cutting grids can divide the piece of food into the plurality of smaller pieces, while the corresponding mover comprising the punch, the corresponding cutting grid and the piece of food disposed on the punch move synchronously with one another in the conveying direction. Alternatively thereto, the cutting grids and corresponding punches can move in a section synchronously with the packages and the corresponding punch can press the piece of food from above through the cutting grid, while the cutting grid, the punch, the piece of food and the package move in the conveying direction. Generally speaking, the cutting grids can move along a circular path, wherein one part of the circular path extends parallel to a transport path for the pieces of food.

According to a variant that can be implemented with a simpler design, the cutting grids do not move with the pieces of food, but are arranged in a stationary manner or only move perpendicular to the conveying direction, for example, in the cutting direction and against the cutting direction.

The object is also satisfied by an apparatus for cutting a piece of food into a plurality of smaller pieces, in particular into a plurality of smaller cubes, said apparatus comprising
at least one cutting grid,
at least one punch to press the piece of food through the cutting grid, and
at least one gripper, wherein the gripper can be moved into a region above the cutting grid to place the piece of food on an upper side of the cutting grid or a support surface movable by the cutting grid or to pick up the plurality of smaller pieces from the upper side of the cutting grid or a support surface movable by the cutting grid.

The apparatus can be configured in two ways. Either the punch presses the piece of food through the cutting grid from bottom to top. In this case, the gripper can serve to pick up, i.e. to lift, the plurality of smaller pieces, for example from the upper side of the punch. Or the punch presses the food through the cutting grid from top to bottom. In this case, the gripper serves to place the piece of food directly on the cutting grid or on a support surface, which can be moved away downwardly by the cutting grid, before the cutting.

Both alternatives have in common that a gripper is provided to handle the food product. It is hereby possible to cut food slices in a fully automated manner into smaller pieces such that the outer shape of the food slice is retained, i.e. the smaller pieces produced from the food slice remain in their grid arrangement.

According to one embodiment, the gripper is configured as a mechanical gripper and/or as a vacuum gripper. The gripper can be configured as described above or below. The gripper can be coupled to a movement unit, i.e., for example, to a robot arm or a 3-axis positioning system. The gripper can preferably be moved into the region above the cutting grid by means of the movement unit.

The gripper can have a release aid to be able to remove adhering food from the gripper. For example, the gripper can have, at at least one holding surface, at least one outlet opening that can be flowed through by gas in order to release a food adhering to the holding surface from the holding surface by means of compressed air or gas. Alternatively or additionally, the gripper can comprise at least one release punch that can be moved out of a holding surface of the gripper in order to release a food adhering to the holding surface from the holding surface.

According to one embodiment, the cutting grid defines a plurality of substantially horizontally arranged cutting edges during operation. The punch can be movable substantially perpendicular to the cutting edges, i.e. movable in a perpendicular manner in the present case. The punch can be supported such that it can be moved from bottom to top and from top to bottom. Alternatively or additionally, a plurality of the cutting edges can be arranged slanted to the horizontal. If the punch is moved perpendicular to the horizontal, a required cutting force can be reduced by the slanted arrangement of the cutting edges since the piece of food is first partly cut. It would generally also be conceivable to orient the cutting edges slanted to the horizontal and to move the punch perpendicular to the cutting edges.

According to one embodiment, the punch has a punch surface, wherein grooves corresponding to the cutting grid are provided in the punch surface. The grooves are designed so that the cutting grid dips into the grooves when the piece of food has been pressed through the cutting grid, and the cutting grid thus does not collide with the punch.

The punch surface preferably forms a plurality of partial punch surfaces surrounded by the grooves. At least some of the partial punch surfaces, in particular all the partial punch surfaces, can have a corner-free, in particular circular, periphery. In other words, peripheral surfaces of sections of the punch defining partial punch surfaces can be designed without edges. The grooves of the at least one punch can hereby be cleaned more easily.

To make the punch lighter, at least some of the partial punches can be hollow. However, the partial punches can still have a full-surface, i.e. closed, partial punch surface. According to a light and particularly easy-to-clean variant, the partial punches can comprise a partial punch plate, in particular a full-surface partial punch plate, that is held in position by a plurality of limbs. In general, lateral openings can be provided that connect the environment of the partial punches with a respective inner space of the partial punches.

According to one embodiment, the punch has a drive. In other words, the punch is coupled or can be coupled to a drive in order to move the punch in the cutting direction, in particular in a vertical direction. The drive is preferably configured to press the piece of food independently through the cutting grid.

The drive of the punch can be configured as a servomotor or a pneumatic drive. In this respect, the servomotor has the advantage that the speed of the punch can be varied/controlled via the cutting process in order, for example, to initially move the punch more slowly during a cutting and to then accelerate the punch again.

The drive of the punch can be fastened in a stationary manner to an apparatus frame or to the at least one mover.

In order to reliably couple a stationary drive and a punch moving along a transport path during operation, centering devices can be provided that perform a centering of the punch relative to the drive on a coupling of the drive, in particular a drive element, such as a cylinder, to the punch. For example, at each punch, at least one centering device, e.g. a conical pin, can be provided that engages into a centering device, e.g. a bore, at the drive element. Alternatively thereto, at each punch, at least one centering device, e.g. a conical bore, can be provided, into which a centering device, e.g. a conical pin, engages at the drive element. Two centering devices are preferably provided at the punch and interact with two corresponding centering devices at the drive element. A rotational misalignment of the punch relative to the drive can hereby also be corrected. The skilled person will recognize that different kinds of centering devices are conceivable.

In order to reduce a maximum required feed force for the punch, it is advantageous if the cutting grid has a plurality of cutting edges arranged spaced apart from one another in the direction of movement of the punch. In other words, the cutting edges can be arranged on different planes so that the piece of food first comes into contact with a first group of cutting edges and only then comes into contact with a second group of cutting edges when the first group of cutting edges has already dipped into the piece of food. Preferably, the cutting grid has longitudinal cutting edges and transverse cutting edges. In other words, the cutting grid has first cutting edges and second cutting edges oriented transversely, in particular perpendicular, to the first cutting edges. For example, the longitudinal cutting edges can be arranged on one plane and the transverse cutting edges on another plane. According to one embodiment, the longitudinal cutting edges can be arranged on different planes. Alternatively or additionally, the transverse cutting edges can be arranged on different planes.

According to one embodiment, the cutting grid is configured as a wire grid having a plurality of wires. In other words, the cutting edges of the cutting grid are preferably formed by wires. The use of wires inter alia has the advantage that a cutting resistance and thus the maximum required feed force for the punch are reduced. To further reduce the maximum required feed force for the punch, at least some of the wires of the wire grid can be arranged spaced apart from one another in the direction of movement of the punch. Preferably, the cutting grid has longitudinal cutting wires and transverse cutting wires. For example, the longitudinal cutting wires can be arranged on one plane and the transverse cutting wires on another plane. According to one embodiment, the longitudinal cutting wires can be arranged below one another on different planes. Alternatively or additionally, the transverse cutting wires can be arranged below one another on different planes.

According to an alternative embodiment, the cutting grid is formed by blades. Blades within the meaning of this application are cutting elements that, when used as intended, can at most be bent slightly in the cutting direction by the contact with the piece of food. For this purpose, the blades can have an extent in the cutting direction that is a multiple of a width of the blade. To minimize friction, the blades can be subjected to vibrations in the ultrasonic range. The apparatus can comprise an oscillation generator for this purpose.

According to one embodiment, the wires of the cutting grid are each fastened to two suspensions arranged spaced apart from one another. In order to reduce the maximum required feed force for the punch, one of the suspensions, in particular at least one suspension per wire, can be designed as flexible.

According to one embodiment, a pneumatic element or a hydraulic element is provided that effects a flexibility of the at least one suspension. Alternatively, a spring element can be provided that effects the flexibility of the suspension. For a detailed description of how the wires of the cutting grid can be made flexible, reference is made to the German patent application DE 10 2019 108 452. In order to save installation space, two wires of the cutting grid, in particular two wires of the cutting grid arranged parallel to one another and directly next to one another, can be coupled to the same pneumatic element, hydraulic element or spring element so that a movement of the pneumatic element, hydraulic element or spring element allows a curvatures of the two wires. Preferably, the two wires are coupled to a common suspension that is designed as flexible by a pneumatic element, hydraulic element or spring element. The suspension can be pivotable to compensate for differences between tensile stresses of the two wires.

According to one embodiment, at least one of the wires of the wire grid is preloaded or can be preloaded. Setting devices can be provided for a setting, in particular an automatic setting, of a tensile stress applied to the wire by the suspensions.

According to one embodiment, all the wires of the wire grid are each fastened to two suspensions arranged spaced apart from one another. The suspensions of the wires of the wire grid can be connected to one another via a frame.

The cutting frame can be removable from the rest of the apparatus and/or can be fastenable to the rest of the apparatus. Preferably, the cutting frame can be removable from the rest of the apparatus and/or fastenable to the rest of the apparatus without tools, i.e. without having to use tools.

In order, for example, to be able to move the frame into an inactive position, for example to process other foods using the apparatus or to clean the frame, the frame can be pivotably arranged at a machine frame about a defined pivot axis. For example, the frame can be arranged in a receiver that is pivotably arranged at the machine frame relative to the machine frame. The pivot axis can be vertically or horizontally arranged in operation.

According to one embodiment, the frame has grooves in which the wires lie. The grooves are preferably adapted to the wires in terms of their width so that they represent a lateral guidance for the wires. A lateral movement of the wires can hereby be reduced and the cutting precision can be increased.

According to one embodiment, at least one of the wires of the wire grid is clamped between the suspensions under tensile stress. A force measurement device can be provided to measure the tensile stress acting on the wire. Alternatively or additionally, force control devices can be provided to control a return force acting on the wire. Force regulating devices could also be provided to regulate the return force acting on the wire.

According to one embodiment, devices for recognizing damage to the wire grid are provided. The devices for recognizing damage to the wire grid can be configured and set up to detect a tearing of one of the wires. For example, a sensor can be provided that detects a pressure increase or a pressure drop in a pneumatic or hydraulic chamber in order to recognize damage to the wire grid therefrom. The pressure increase or pressure drop measured by the sensor can also be used to recognize how long the cutting process will take or when the cutting process will be completed. For example, cutting times of different lengths can occur due to different types of food, different external conditions such as temperature and humidity, and/or different properties of the wires. In order to dynamically adapt the temporally subsequent process steps to the cutting times, the pressure measured by the sensor can be evaluated and, from certain threshold values, for example a drop in pressure above a certain threshold value, a subsequent process step, such as a picker moving off, e.g. to place a new piece of food or pick up cut pieces of food, a mover moving off, etc., can be initiated.

The pressure increase or pressure drop measured by the sensor can also be used to recognize which type of food product, for example which type of cheese, is currently being processed, provided that a consistency of the food products to be differentiated have a sufficiently large deviation from one another.

According to one embodiment, the punch is coupled or can be coupled to a mover of a transport system. The transport system can be configured to transport the piece of food disposed on the punch under the cutting grid. The punch can be movable in a vertical direction relative to the mover in order to press the piece of food through the cutting grid. A drive can be provided to move the punch relative to the mover.

According to one embodiment, a plurality of punches are provided. A plurality of movers can furthermore be provided. At least one of the punches can be coupled or couplable to one of the movers of the transport system in each case. For example, each mover can have coupling devices for exactly one punch or exactly two punches. The coupling devices can, for example, be configured as a frame. The frame can have at least one opening or recess defined by the frame. A corresponding fixing device of the punch can be introducible into the opening or recess. The transport system can be configured to successively transport the pieces of food, either individually disposed on one of the punches or disposed as a plurality next to one another on punches coupled to a mover, under the cutting grid.

According to one embodiment, the apparatus is configured to cut a plurality of pieces of food at the same time in that a first piece of food is pressed through a first cutting grid by means of a first punch, while a second piece of food is pressed through a second cutting grid by means of a second punch. The throughput of the apparatus can hereby be increased. The gripper can be configured to place the first and the second piece of food onto the respective cutting grids, i.e. the first and the second cutting grid. The gripper can also be configured to place the first and the second piece of food on a respective support surface movable by the respective cutting grid. This support surface can be configured like a punch surface and can move back against the cutting direction on a cutting by the cutting grid. Alternatively thereto, the gripper can be configured to lift first smaller pieces cut from the first piece of food and second smaller pieces cut from the second piece of food. For example, the gripper can be configured to successively lift the first smaller pieces and the second smaller pieces.

The first piece of food and the second piece of food can each rest on a separate punch while they are pressed from below through the cutting grid. Alternatively thereto, the first piece of food and the second piece of food can each rest on a separate cutting grid or a separate structure that can be moved by the cutting grid, and can be acted upon from above by the respective punch.

The apparatus preferably comprises an alignment unit to align the piece of food to be cut to match the alignment of the cutting grid. The alignment unit can be arranged in front of the cutting grid, viewed in the transport direction. Alternatively thereto, the alignment unit can be integrated into the cutting frame.

According to one embodiment, the alignment unit comprises two substantially L-shaped alignment elements that are movable along a diagonal towards the piece of food. A respective limb of each alignment element can hereby come into contact with a side surface of the piece of food and can thus align the piece of food. In order to avoid a deformation of the corner edges in the case of pieces of food with pointed corner edges, the alignment elements can have a recess in a transition region between the limbs so that the corner edges of the pieces of food do not come into contact with the respective alignment element.

The alignment unit can be controlled such that the alignment unit performs an alignment movement for each piece of food, i.e. regardless of whether the piece of food is already correctly aligned or not. Alternatively thereto, a detection device, e.g. a camera, can detect an alignment of the respective piece of food and the alignment unit can only be activated if the piece of food is oriented in a slanted manner such that a correction of the alignment of the piece of food is necessary. Preferably, a threshold value for a permissible deviation of the alignment of the piece of food can be set at the apparatus.

The invention furthermore relates to a food processing line comprising an apparatus as described above or below and a slicer, a sorting and conveying line and/or a packaging machine.

### BRIEF DESCRIPTION OF THE DRAWINGS

The invention will be described with reference to purely exemplary embodiments and to the enclosed drawings in the following. To make it easier to compare the different embodiments, the corresponding components are labeled with the same reference symbols. There are shown:

FIG. 1A a perspective representation of an apparatus according to the invention in accordance with a first embodiment with the cutting unit masked in a providing stage;

FIG. 1B a perspective representation of the apparatus of FIG. 1A with the cutting unit shown in the providing stage;

FIG. 2A a perspective representation of the apparatus of FIG. 1A with the cutting unit masked after a cutting process;

FIG. 2B a perspective representation of the apparatus of FIG. 1A with the cutting unit shown after the cutting process;

FIG. 3A a side view of the apparatus of FIG. 1A in the providing stage;

FIG. 3B a side view of the apparatus of FIG. 1A after the cutting process;

FIG. 3C a lateral sectional view of the apparatus of FIG. 3B;

FIG. 4A a perspective representation of an apparatus according to the invention in accordance with a second embodiment in a providing stage;

FIG. 4B a perspective representation of the apparatus of FIG. 4A after a cutting process;

FIG. 5A a side view of the apparatus of FIG. 4A in the providing stage;

FIG. 5B a detailed view of FIG. 5A;

FIG. 6A a side view of the apparatus of FIG. 4A in a lifting stage;

FIG. 6B a side view of the apparatus of FIG. 4A in a cutting stage;

FIG. 7A a side view of the apparatus of FIG. 4A after the cutting process;

FIG. 7B a side view of the apparatus of FIG. 4A with the punch lowered;

FIG. 8A a perspective detailed view of a scraping device of the apparatus of FIG. 4A in a starting position;

FIG. 8B a perspective detailed view of a scraping device of the apparatus of FIG. 4A in a pressed-in position;

FIG. 9A a perspective detailed view of a punch of the apparatus of FIG. 4A in a starting position;

FIG. 9B a perspective detailed view of the punch of the apparatus of FIG. 4A in a pressed-in position;

FIG. 10 a perspective detailed view of a gripper and a cutting unit of the apparatus of FIG. 4A;

FIG. 11 an end-face sectional representation of an apparatus according to the invention in accordance with a further embodiment in a providing stage;

FIG. 12 a lateral sectional representation of the apparatus of FIG. 11;

FIG. 13 an end-face sectional representation of the apparatus of FIG. 11 after a cutting stage;

FIG. 14 an end-face sectional representation of the apparatus of FIG. 11 in a lifting stage;

FIG. 15 a plan view of a part section of a food processing line with the apparatus of FIG. 11;

FIG. 16 an end-face sectional representation of an apparatus according to the invention in accordance with another further embodiment in a placing stage;

FIG. 17 an end-face sectional representation of the apparatus of FIG. 16 in a punch moving stage;

FIG. 18 an end-face sectional representation of the apparatus of FIG. 16 in a cutting stage;

FIG. 19A a plan view of a part section of a food processing line with the apparatus of FIG. 16;

FIG. 19B a lateral detailed view of the apparatus of FIG. 19A;

FIG. 20A a view of a punch surface in accordance with a first embodiment;

FIG. 20B a representation of the punch surface of FIG. 20A together with a corresponding cutting frame;

FIG. 21A a view of a punch surface in accordance with a second embodiment;

FIG. 21B a representation of the punch surface of FIG. 21A together with a corresponding cutting frame;

FIG. 22A a side view of a cutting frame in accordance with a first embodiment;

FIG. 22B a side view of a cutting frame in accordance with a second embodiment;

FIG. 22C a perspective view of gripping elements defining holding surfaces in accordance with a first embodiment;

FIG. 22D a perspective view of gripping elements defining holding surfaces in accordance with a second embodiment;

FIG. 23A a perspective side view of a vacuum gripper;

FIG. 23B a side view of an exemplary movement unit for a gripper;

FIG. 24A a lateral sectional representation of a flexible wire suspension in accordance with a first embodiment;

FIG. 24B a lateral sectional representation of a flexible wire suspension in accordance with a second embodiment;

FIG. 25A a schematic side view of a receiver for a cutting frame; and

FIG. 25B a detailed view of a variant of the apparatus of FIG. 11 in which centering devices are shown between a punch and a drive element, on the one hand, and hollow partial punches are shown, on the other hand.

### DETAILED DESCRIPTION

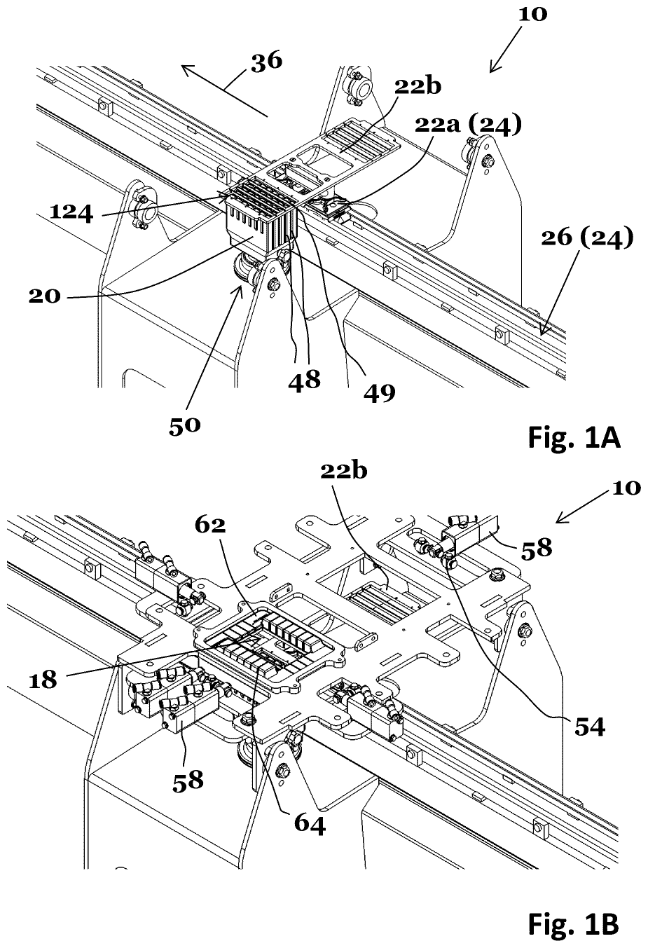

In FIGS. 1A to 3C, a first embodiment of an apparatus 10 for the automated cutting of a piece of food 12a into a plurality of smaller pieces 12b is shown. This apparatus 10 is configured to produce a plurality of smaller cubes 12b from a piece of food 12a, e.g. a cheese slice.

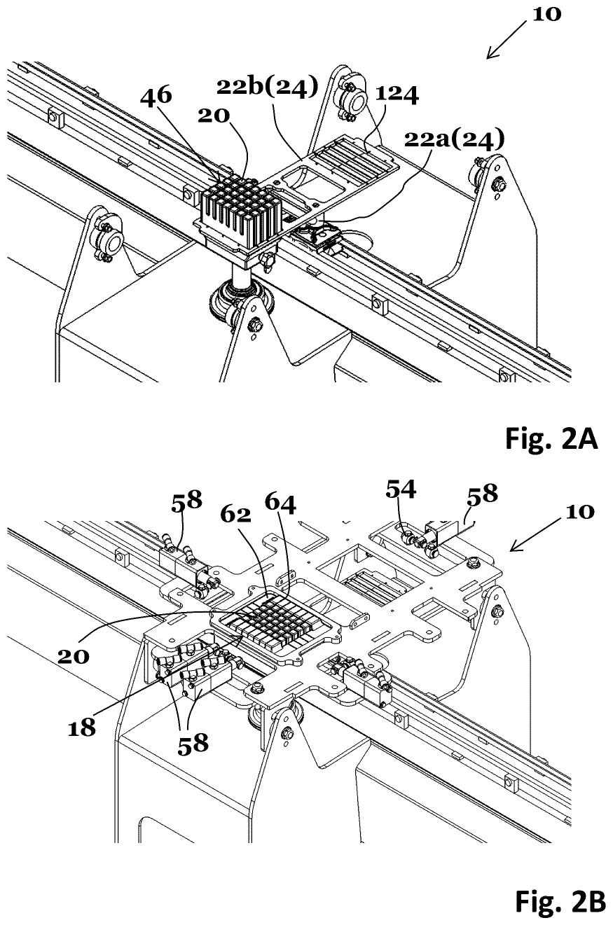

FIGS. 1A to 2B show perspective representations of the apparatus 10. The apparatus 10 comprises a transport system 24 to transport pieces of food 12a under a cutting unit 18 (see FIG. 1B). The transport system comprises a plurality of movers 22 that can also be called transport movers. One example of such a transport system comprising transport movers is the Weber ShuttleSystem (WSS). This system is based on a so-called LSM drive, i.e. a drive via linear synchronous motors. In an LSM drive, the magnetic field of a runner is provided by permanent magnets. In the present example, the movers 22 each comprise a runner 22a cooperating with a transport path 26, i.e. the stator. Each of the runners 22a is equipped with at least one permanent magnet PM. In order to drive the movers 22 along their transport path 26, the transport path 26 is configured to generate a traveling electromagnetic field. The drive principle of an LSM drive can be visualized such that the mover 22 provided with the permanent magnet PM is pulled along the transport path 26 by the magnetic field moving along the transport path 26.

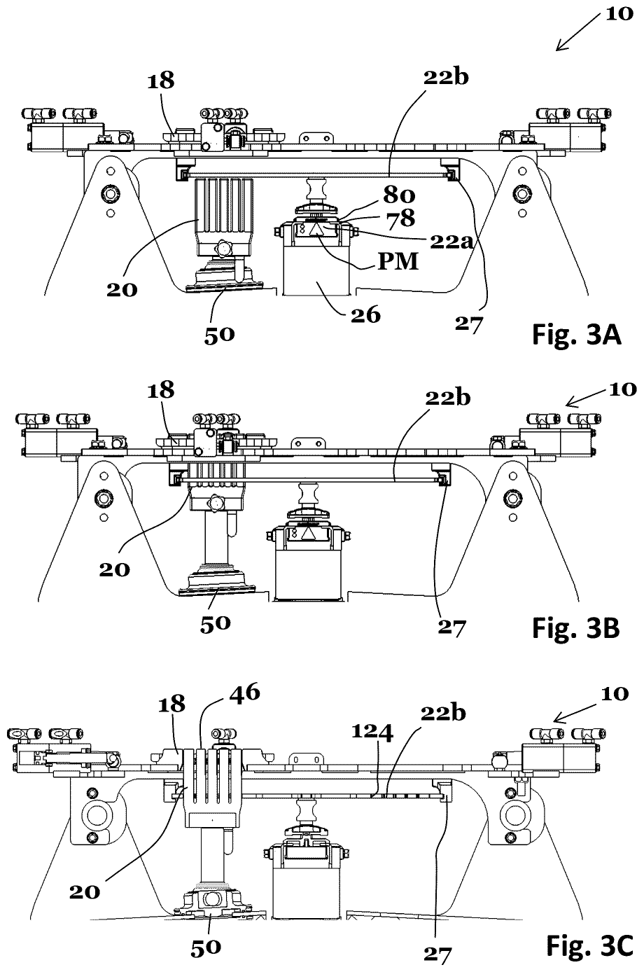

Guide rails 78 (see FIG. 3A) that are designed as angled metal sheets and that run in slots 80, which are formed at the left and right side surfaces of the runner 22a of the mover 22, serve as a guide for the mover 22 here. The guides of the transport path 26 for the movers 22 can, however, also be differently designed.

The movers 22 each comprise a support structure 22b. The support structure 22b forms a planar support surface for the piece of food 12a. As shown in the Figures, two support structures 22b can be provided per mover 22. Alternatively thereto, it is conceivable to provide four support structures, i.e. four spaces for one piece of food 12a, per mover.

Elongate recesses 124 (see FIG. 1A) are formed in the support structure 22b in a region of the support surface. The recesses 124 extend from an underside of the support structure 22b to an upper side of the support structure 22b. In other words, the recesses 124 extend through the support structure 22b. As can be seen from a comparison of FIGS. 1A and 2A, the recesses 124 are configured to be engaged through by a punch 20.

In the embodiment shown, the punch 20 is arranged in a stationary manner. When the support structure 22b has been moved by means of the transport system 24 so that the support structure 22b is arranged above the punch 20, the punch 20 can be moved from below through the support structure 22b (cf. FIG. 2A) in order to lift the piece of food 12a from the support structure 22b. For this purpose, the punch 20 has a plurality of grooves 48 that are configured to receive webs 49 of the support structure 22b that bound the recesses 124. The punch 20 is coupled to a drive 50 that serves to move the punch 20 in a vertical direction. The drive 50 is configured as a servomotor in the present case. However, the drive 50 can also be configured as a pneumatic drive, for example.

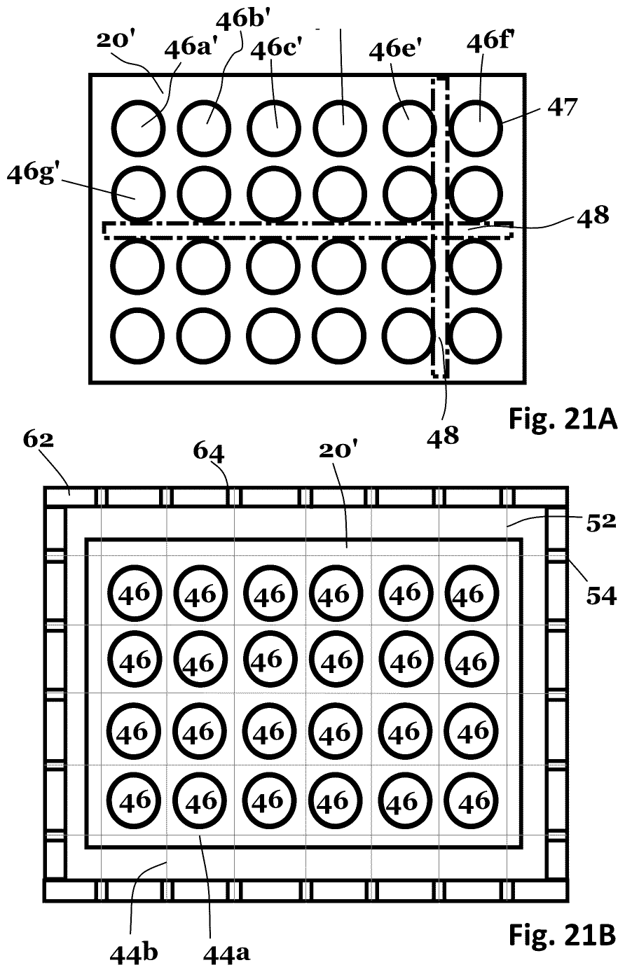

In FIGS. 1B and 2B, the cutting unit 18 of the apparatus 10 is shown. In the present embodiment example, the cutting unit 18 is configured in the form of a cutting grid. A detailed view of the cutting grid is shown in FIG. 21B. The cutting grid 18 is formed by a plurality of longitudinal wires 52 and a plurality of transverse wires 52, wherein the longitudinal wires 52 are preferably arranged at right angles to the transverse wires 52. The longitudinal wires 52 form longitudinal cutting edges 44a and the transverse wires 52 form transverse cutting edges 44b.

The wires 52, i.e. the longitudinal wires and the transverse wires, are clamped in a rectangular frame 62, also called a cutting frame. Grooves 64, in which a respective one of the wires 52 lies, are formed at the frame 62. The grooves 64 are adapted to the thickness of the wires 52 in terms of their width and serve to laterally guide the wires 52. The cutting accuracy is hereby improved.

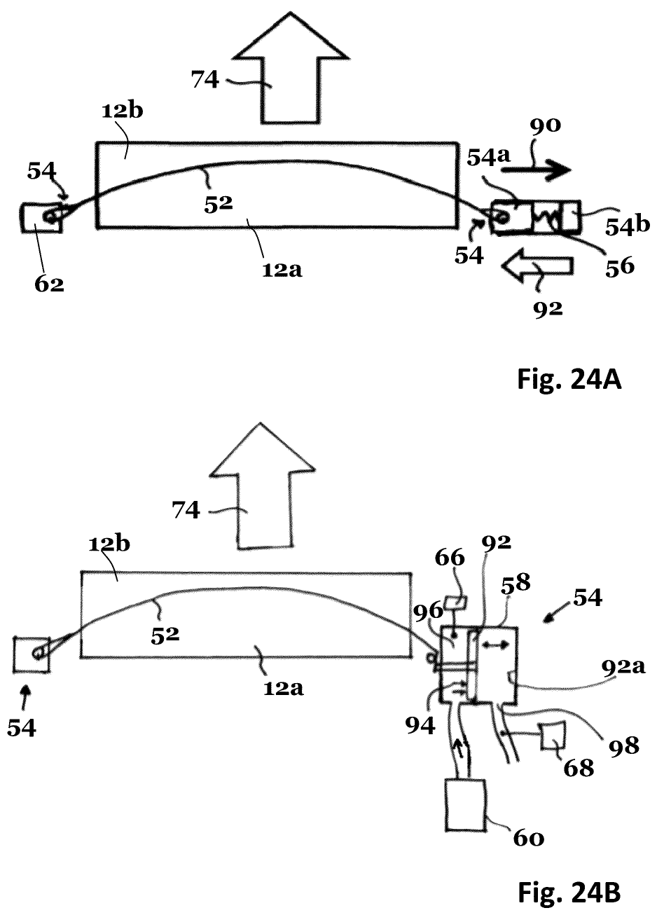

The wires 52 are preloaded by pneumatic elements 58, in particular pneumatic cylinders. As a result, the wires 52 are designed as flexible, whereby the service life of the wires 52 can be significantly improved. FIG. 24B shows in detail how the respective wire 52 can bend due to the flexible suspension. In order to save pneumatic elements 58 and thus installation space, two wires can be coupled to one pneumatic element 58 so that one pneumatic element 58 preloads two wires 58. Preferably, the wires 58 are connected to a suspension 54 at oppositely disposed sides with respect to a piston axis of the pneumatic element 58 in order to avoid bending moments on the pneumatic element 58. The suspension 54 can be pivotably coupled to the pneumatic element 58, preferably about a vertical axis, in order to compensate for tensile stress differences between the wires 52 connected to the pneumatic element 58.

The grooves 48 in the punch 20, in addition to receiving the webs 49 of the support structure 22b, also serve to receive the cutting grid 18, and thus prevent a collision between the punch 20 and the cutting grid 18 during a cutting process.

FIGS. 3A to 3C show the movement of the punch 20 during the cutting process from a side view. In FIG. 3A, the mover 22 is in a position along the transport path 26 in which the support structure 22b is arranged between the punch 20 and the cutting unit 18. As can be seen from the comparison of FIGS. 3A and 3B, the drive 50 then moves the punch 20 upwards from a lowered position in a vertical direction. In this respect, the punch 20 first picks up a piece of food 12a, not shown, disposed on the support structure 22b and then presses the piece of food 12a completely from below through the cutting unit 18 that is configured as a cutting grid in the present example. The piece of food 12a is hereby cut into a plurality of smaller pieces 12b, for example cubes, disposed in a grid arrangement.

As can be seen from FIG. 3C, the plurality of smaller pieces 12b present in a grid arrangement are disposed on the punch surface 46 at the end of the cutting process and can be lifted from said punch surface 46 by means of a gripper 14 not shown in FIG. 3C, for example, a mechanical gripper 14a or a vacuum gripper 14b. The punch 20 is then moved back into its lowered position again, for example, by means of the drive 50. The mover 22 is hereby released so that the mover 22 can move further along the transport path 26 and can make room for the next mover 22.

To ensure that the support structure 22b is correctly positioned under the punch 20 and/or is securely held during the cutting process, at least one guide 27 can be provided that positions and/or holds the support structure 22b in position.

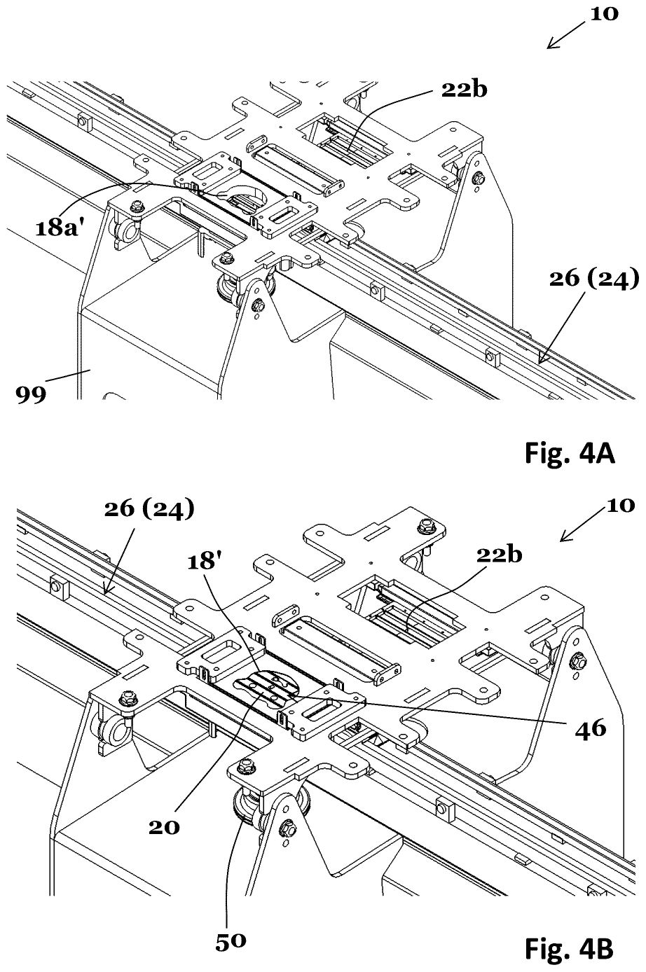

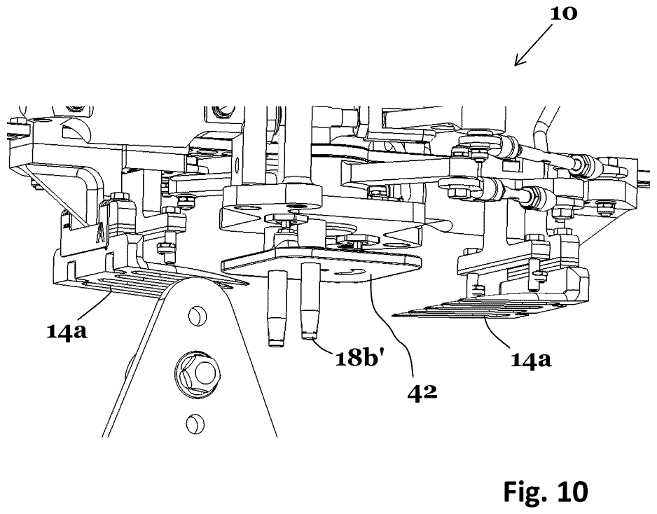

FIGS. 4A to 10 show a further embodiment in which the piece of food 12a is pressed through a cutting unit 18 to cut the piece of food 12a into a plurality of smaller pieces 12b. In this embodiment, the piece of food 12a is also pressed from below through the cutting unit 18. However, in this embodiment, the piece of food 12a is not cut into a plurality of smaller cubes, but into a cut-out shape, namely a bear face, and a remainder. For this purpose, the apparatus comprises a cutting mold 18′ as the cutting unit 18. The cutting mold 18′ comprises an outer contour mold 18a′ fixedly coupled to a machine frame 99 and a plurality of inner contour molds 18b′, preferably coupled to a gripper 14 (see e.g. FIG. 10). Only the inner contour molds 18b′ for creating the eyes are shown in FIGS. 4A to 10. It is understood, however, that inner contour molds 18b′ are furthermore provided for the nose and the mouth to be able to cut the face completely out of the piece of food 12a.

FIG. 4A shows—corresponding to FIG. 1B—a perspective representation of the mover 22 below the cutting unit 18′. The transport system 24 including the support structure 22 corresponds to the transport system 24 of the first embodiment described above. Thus, the transport system 24 can be used for both applications, namely for producing cubes 12b and for producing shapes 12b. The system thus makes it possible to change the apparatus from a cutting unit for cubes to a cutting unit for shapes without having to make changes to the transport system, e.g. without having to replace the support structure. As shown in the present embodiments, an interface can be provided by means of which the cutting units 18 can be exchanged by removing them from the machine frame 99 and fastening another cutting unit 18′ to the machine frame 99.

FIG. 4B shows—corresponding to FIG. 2B—a perspective representation in which the punch 20 has moved into an upper end position. In this punch position, it is possible for the gripper 14 to lift a cut-out shape 12b from the punch surface 46. In the present case, the apparatus 10 is designed such that a gripper 14 can grip laterally under the shape 12b and can hereby safely lift the shape 12b from the punch surface 46.

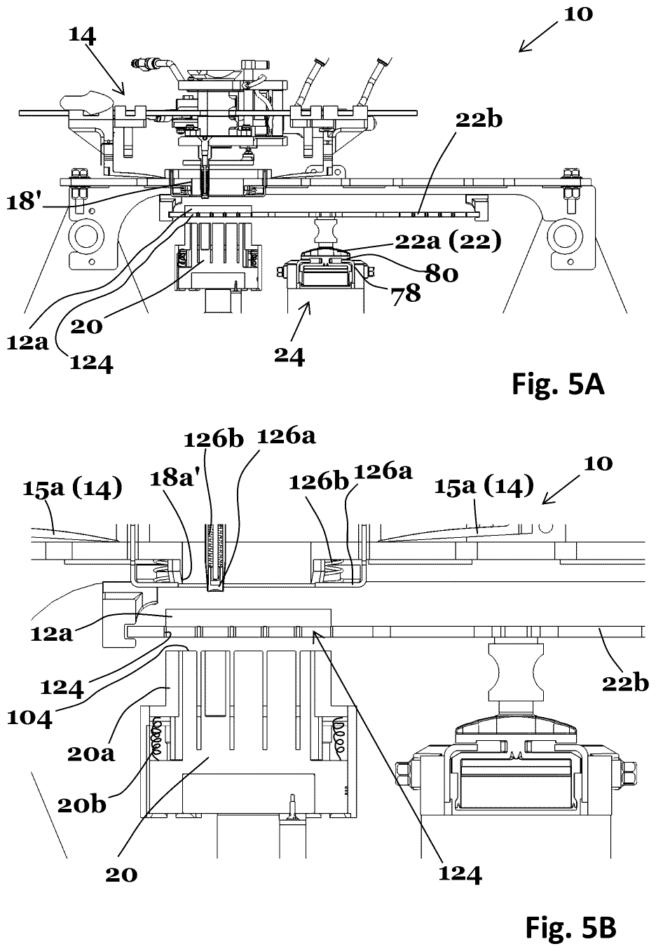

FIG. 5A shows the apparatus 10 including the gripper 14. As can be seen from FIG. 5A, the gripper 14 comprises two blade-like gripping elements directed towards one another that can be moved towards one another in order to grip under the shape 12b coming from two opposite sides. To place the shape 12b, the gripper elements are moved away from one another again in the opposite directions. However, it would also be conceivable to lift the shape 12b by means of a different type of gripper, for example, by means of a vacuum gripper.

A cutting process for producing the shape 12b from a piece of food 12a is shown in FIGS. 5B to 7B. FIG. 5B in this respect shows a providing stage in which the piece of food 12a is arranged disposed on the support structure 22b between the punch 20 and the cutting unit 18′.

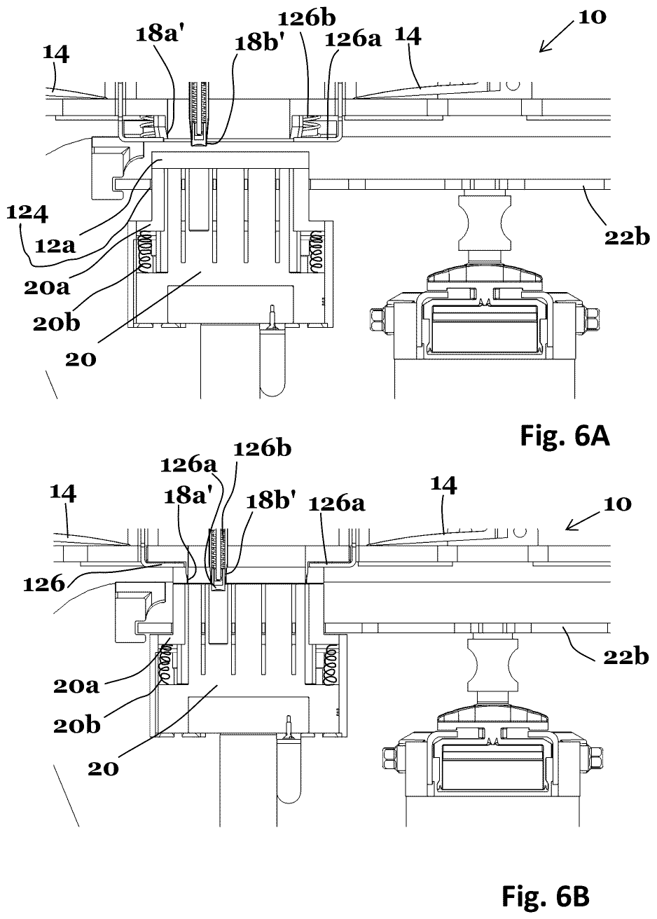

Subsequently, as shown in FIG. 6A, the punch 20 is driven through the support structure 22b coming from below so that the punch 20 sectionally engages through recesses 124 in the support structure 22b and lifts the piece of food 12a from the support structure 22b.

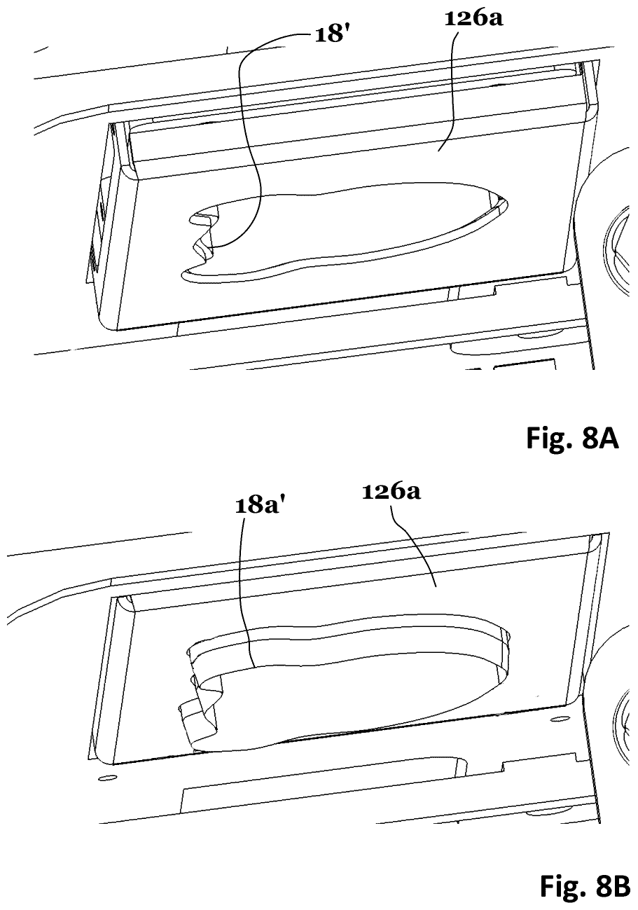

The punch 20 is then moved further upwardly, as shown in FIG. 6B, so that the piece of food 12a comes into contact with the cutting mold 18′. The cutting mold 18′ cuts the piece of food 12a into a shape 12b and a remainder. In this respect, the remainder 12b comes into contact with at least one scraping element 126a of a scraping device 126 during the cutting and presses this scraping element 126a against a spring force of a spring element 126b in the cutting direction, i.e. upwards in the present case. This applies to the part of the remainder that is produced outside an outer contour of the shape 12b, but also to all parts of the remainder produced inside an inner contour, e.g. punched-out eyes. FIGS. 8A and 8B show the scraping element 126a for the remainder outside the outer contour in the starting position and, in comparison thereto, in the pressed-in position.

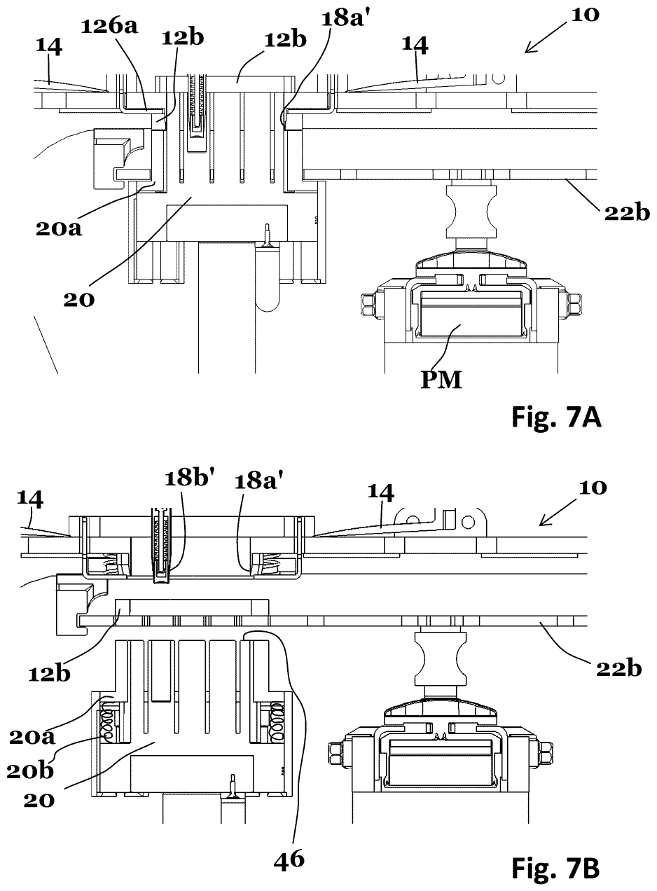

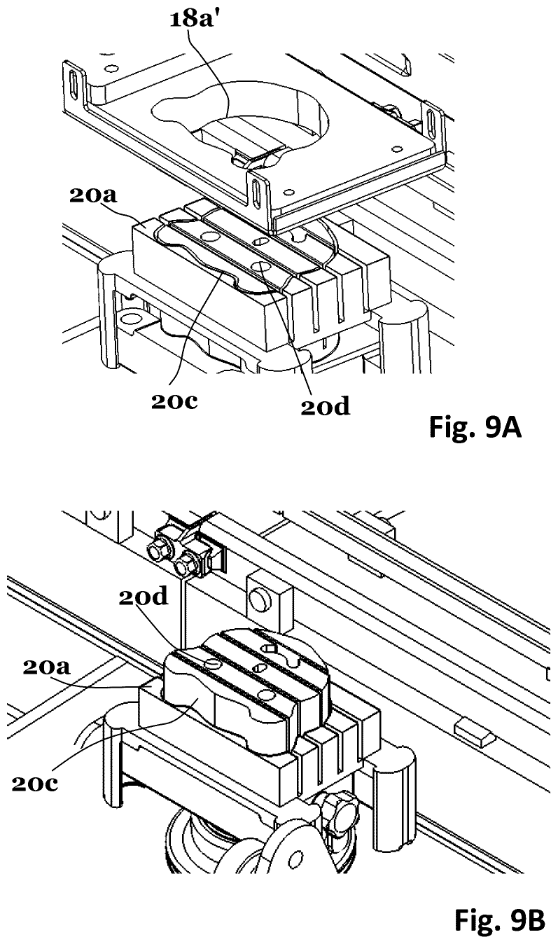

As can be seen from FIG. 7A and the comparison of FIGS. 9A and 9B, the punch 20 has a flexible section or region 20a. The punch 20 furthermore defines an outer contour 20c (see FIG. 9A), which is shaped according to the outer contour mold 18a of the cutting unit 18, and inner contours 20d that correspond to the inner contour molds 18b of the cutting unit 18. The inner contour molds 18b of the cutting unit 18 can hereby engage into the inner contours 20d of the punch 20 during the cutting.

The flexible section 20a corresponds to a region outside the outer contour for the mold. In order, as shown in FIG. 7A, to be able to press the cut-out shape 12b through the cutting unit 18′ so that the shape 12b can be removed from the upper side of the cutting unit 18′, the flexible section 20a is configured such that it can be moved against a spring force of a spring element 20b (see FIG. 6B) against the cutting direction, i.e. downwardly in the present case. As a result, the margin of the punch 12 does not block the movement of the rest of the punch 12 in the cutting direction. Furthermore, the remainder 12b, which is formed outside the outer contour of the shape 12b, can be held between the scraping element 126a for the remainder 12b and the flexible section 20a.

After the shape 12b has been lifted from the punch surface 46, the punch 20 can be moved against the cutting direction again, in the present case downwards. The scraping elements 126a can hereby be moved back into their starting position by the spring elements 126b, whereby the remainder 12b is scraped off from the cutting unit 18′. The remainder 12b can come to rest partly or completely on the support structure 22b and can be transported away by the transport system 24. The flexible section 20a of the punch 20 is also moved back into its starting position in the cutting direction by the corresponding spring elements 20b.

FIG. 10 shows a detailed view of the gripper 14 by means of which the shape 12b can be lifted from the punch 20. In this variant of the gripper 14, the inner contour molds 18b′ of the cutting mold 18′ are connected to the gripper 14 and therefore move with the gripper 14. The gripper 14 is configured to grip the shape 12b, while the inner contour molds 18b′ penetrate the shape 12b, e.g. cheese slices in a bear shape. As a result, the inner contour molds 18b′ form fixations for the shape 12b during a transport with the gripper 14. To release the shape 12b from the inner contour molds 18b′, a release punch 42 can, for example, be provided. The release punch can be movable relative to the inner contour molds 18b′ in order to release the cut-out shape 12b from the inner contour molds 18b′.

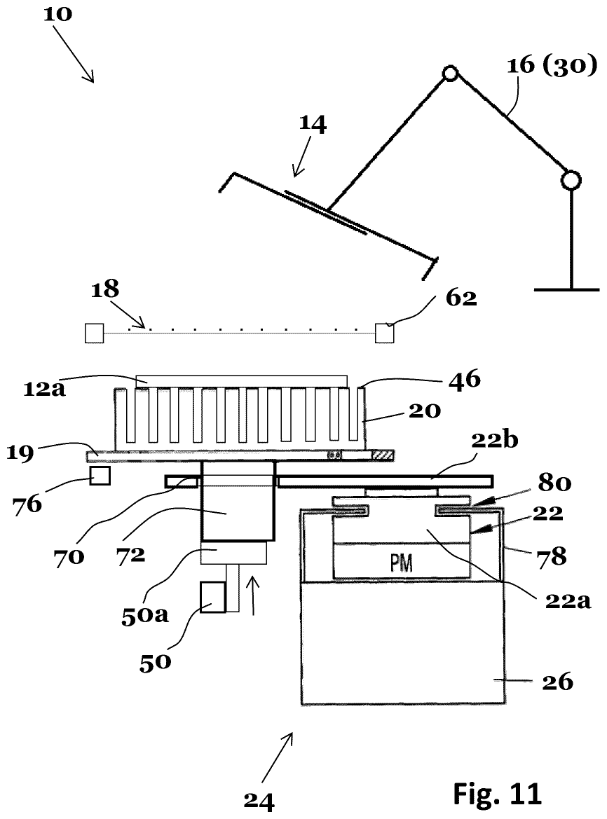

A further embodiment of an apparatus 10 for the automated cutting of a piece of food 12a into a plurality of smaller pieces 12b is shown in FIGS. 11 to 15.

FIG. 11 in this respect shows a cross-section, i.e. a section perpendicular to the conveying direction 36, through a transport system 24 of the apparatus 10. The transport system 24 comprises a plurality of movers 22 that can also be called transport movers. One example of such a transport system comprising transport movers is the Weber ShuttleSystem (WSS). This system is based on a so-called LSM drive, i.e. a drive via linear synchronous motors. In an LSM drive, the magnetic field of a runner is provided by permanent magnets. In the present example, the movers 22 each comprise a runner 22a cooperating with a transport path 26, i.e. the stator. Each of the runners 22a is equipped with at least one permanent magnet PM. In order to drive the movers 22 along their transport path 26, the transport path 26 is configured to generate a traveling electromagnetic field. The drive principle of an LSM drive can be visualized such that the mover 22 provided with the permanent magnet PM is pulled along the transport path 26 by the magnetic field moving along the transport path 26.

Guide rails 78 that are designed as angled metal sheets and that run in slots 80, which are formed at the left and right side surfaces of the runner 22a of the mover 22, serve as a guide for the mover 22 here. The guides of the transport path 26 for the movers 22 can, however, also be differently designed.

The movers 22 each comprise a support structure 22b for a support 19. A punch 20 is arranged on the support 19. Coupling devices 70 are provided at the support structure 22b of the mover 22 in order to hold the support 19 and the punch 20 in a vertically movable, but otherwise fixed manner, at the support structure 22b. For this purpose, the coupling devices 70 comprise an opening in the support structure 22b that is formed with respect to its inner peripheral shape corresponding to an outer peripheral shape of a fixing device 72 attached to the support 19. The support 19 and the punch 20 are hereby movable in a vertical direction, but are, for example, fastened to the support structure 22b in a horizontal direction and fixed against rotational movements. The support 19 has an enlarged outer periphery compared to the opening so that the support 19 is securely held by the support structure 22b and cannot fall downwards through the opening.

FIG. 11 furthermore schematically shows a drive 50 to move the punch 20 in a vertical direction. The drive 50 is configured as a servomotor in the present case. However, the drive 50 can also be configured as a pneumatic drive. In the present case, the drive 50 is arranged in a stationary manner below a likewise stationary cutting grid 18. Alternatively, the drive could also be fastened to the mover 22 and can move along accordingly with the mover 22. When the punch 20 has been placed below the cutting grid 18 by the mover 22, the drive 50 moves a drive element 50a; e.g. a cylinder, against an underside of the fixing device 72 fixedly connected to the punch 20. The punch 20 is hereby lifted and pressed towards the cutting grid 18.

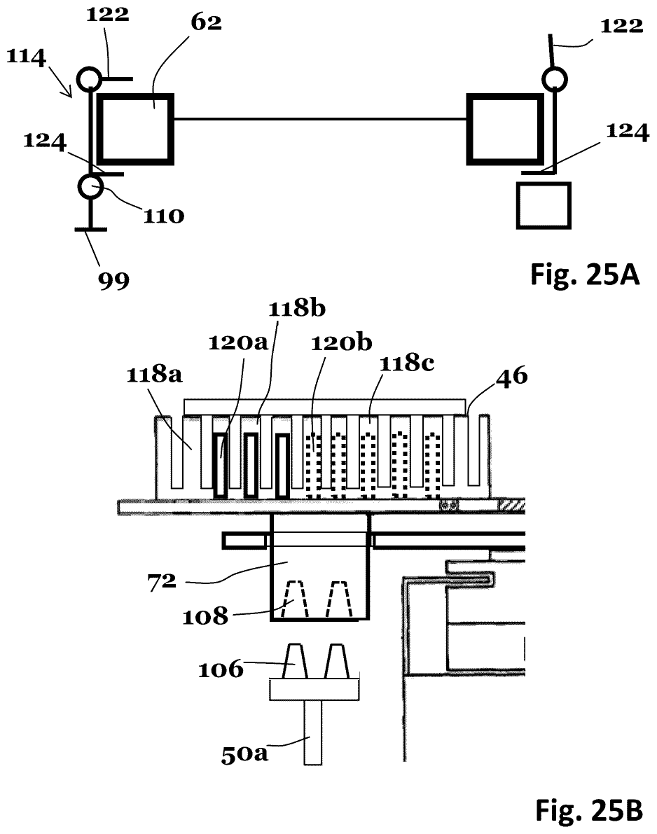

In principle, it is conceivable that the drive element 50a presses with a planar upper side against a planar underside of the fixing device 72. An alternative thereto is shown in FIG. 25B. In this variant, first centering devices 106, for example at least one conical pin, are formed at the drive element 50a and corresponding second centering devices 108, for example at least one conical recess, are formed at the underside of the fixing means 72. The punch 20 can hereby be aligned by the contact with the drive 50.

In the variants described above, the drive element 50a can come directly into contact with the fixing device 72. According to a further—not shown—alternative, it is conceivable that the drive element 50a presses from below against a deformable sliding metal sheet and the sliding metal sheet hereby forms a ramp over which the punch 20 can slide and is thereby lifted.

A lifting rail 76 can be provided to raise the punch 20 in advance and thus to shorten a stroke path for the drive 50. For this purpose, the lifting rail 76 is shaped such that the lifting rail 76 comes into contact with an underside of the support 19 and is lifted by a movement of the support 19 in the conveying direction 36.

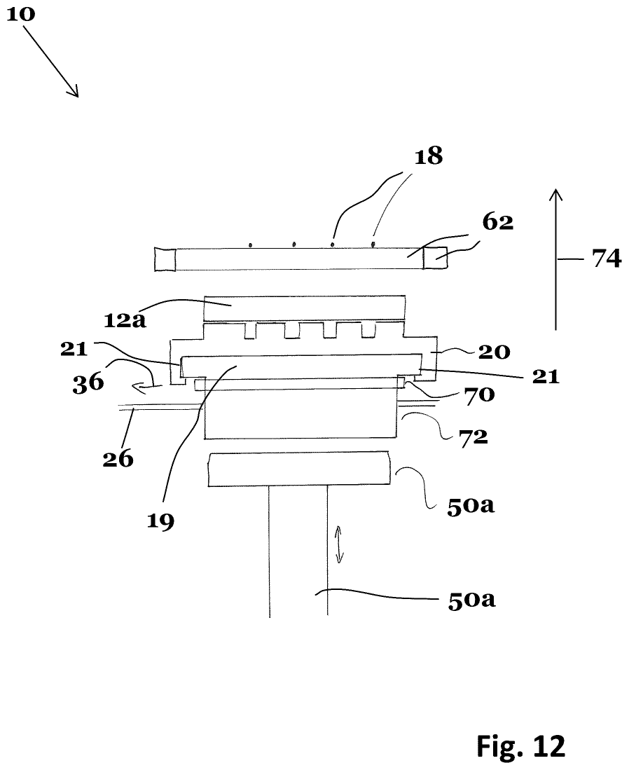

FIG. 12 shows a schematic side view of the transport system 24 of FIG. 11. In this view, it can be seen that the punch 20 is coupled in a form-fitted manner to the support 19 by means of two undercuts 21. However, it would also be conceivable to manufacture the support 19 and the punch 20 in one piece or to couple them together in another way.

The punch 20 serves to press the piece of food 12a, for example a cheese slice, disposed on the punch 20, more precisely on a punch surface 46, upwards through the cutting grid 18 in the cutting direction 74 in order, as a result, to produced cube-shaped smaller pieces 12b.

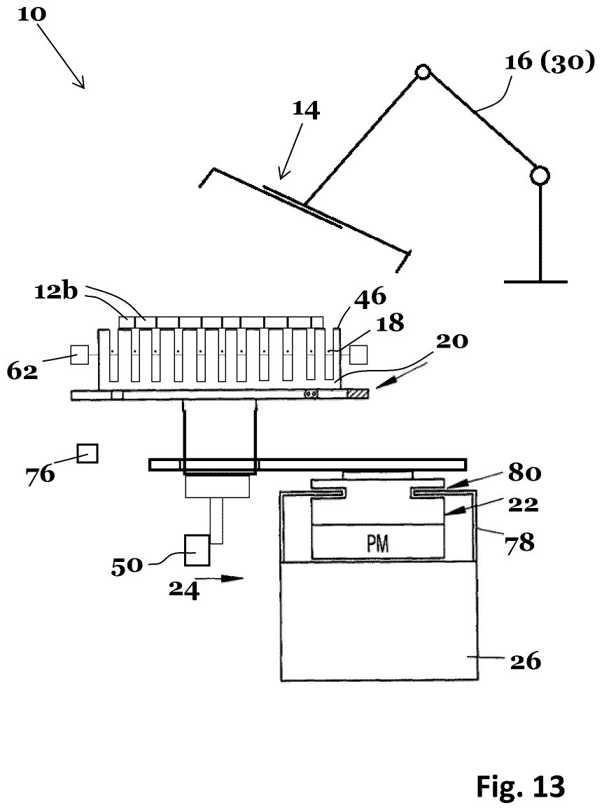

In FIG. 13, the apparatus 10 is shown at a stage at which the piece of food 12a has been pressed completely through the cutting grid 18 and thus the cube-shaped smaller pieces 12b have been produced. The smaller pieces 12b are now disposed on the punch surface 46 in a grid arrangement, i.e. with their side faces arranged orderly against one another.

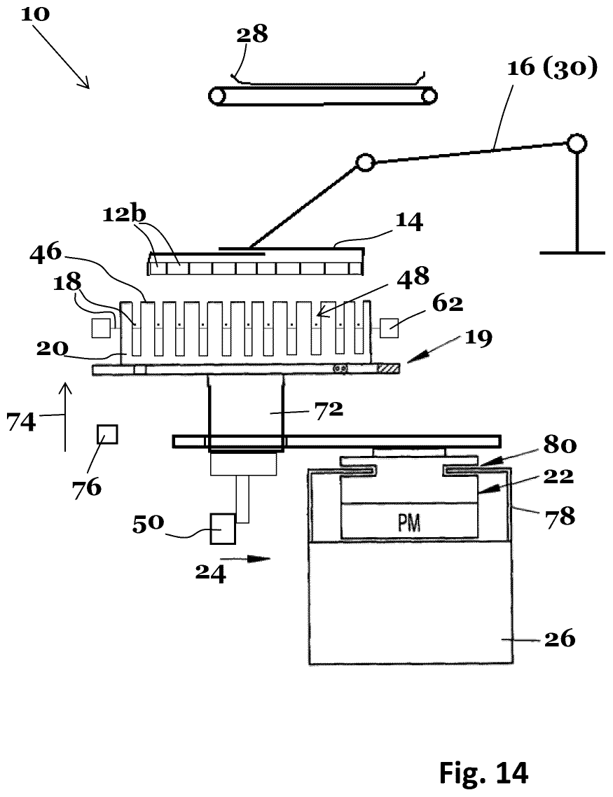

Now, as can be seen in FIG. 14, a gripper 14 associated with the apparatus 10 can jointly lift the cube-shaped smaller pieces 12b arranged in the grid arrangement and place them into a package 28 for the cube-shaped smaller pieces 12b. A movement unit 16, here a robot arm 30, is provided to move the gripper 14 between the punch surface 46 and the package 28.

The punch 20 can then be lowered again and the mover 22 can be moved further along the transport path 26.

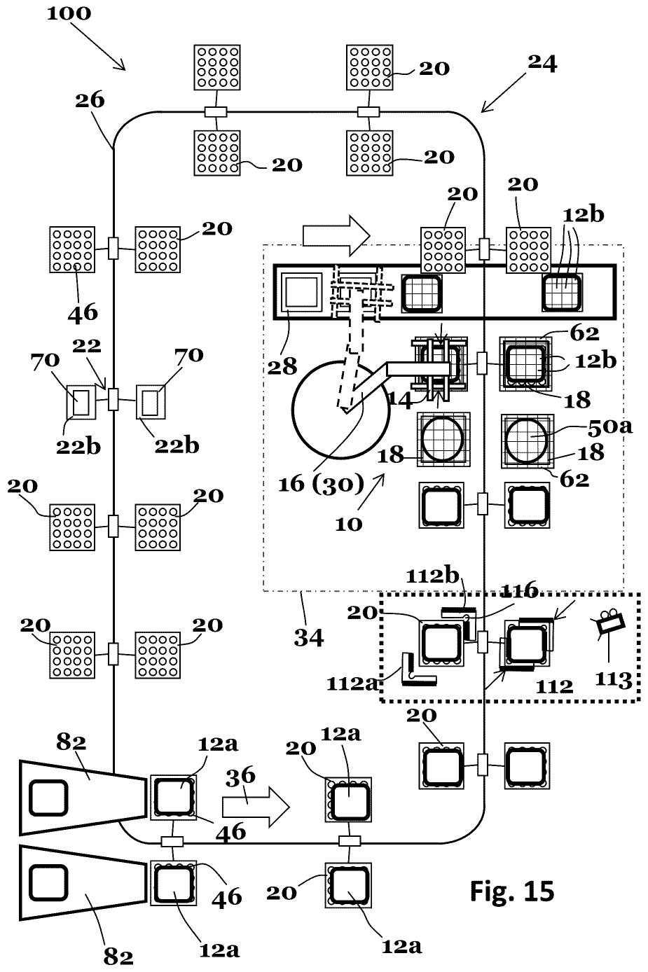

FIG. 15 shows a plan view of a part section of a food processing line 100 with the apparatus 10 for cutting a piece of food 12a into a plurality of smaller pieces 12b. The food processing line 100 comprises the transport system 24 with the transport path 26. As can be seen in FIG. 15, the transport path 26 extends along a circular path. The movers 22 move along the circular path in the conveying direction 36.

At a high-performance slicer, not shown, pieces of food 12a are cut off from a block of food, for example a block of cheese, in the form of slices. They are transported via a transport unit, for example a conveyor belt 82, to the transport path 26 where, as can be seen at the bottom left in FIG. 15, they are placed or dropped onto punch surfaces 46 of the punches 20 coupled to the movers 22.

An alignment unit 112 is provided to ensure that the pieces of food 12a are disposed on the punch 20 in a correctly centered and aligned manner. The alignment unit 112 comprises two L-shaped alignment elements 112a, 112b per track, i.e. per punch 20 that can be attached to the mover 22. They can be moved from positions arranged diagonally to one another towards side surfaces of the respective piece of food 12a disposed on the punch 20 in order to align the piece of food 12a correctly on the punch 20. So that the alignment elements 112a, 112b do not contact the piece of food 12a in a corner region of the piece of food 12a, a recess 116 is formed in a transition region between contact surfaces of the alignment elements 112a, 112b that are oriented perpendicular to one another.

According to one variant, each of the pieces of food 12a can be contacted by the alignment elements 112a, 112b. Alternatively thereto, a detection device 113 can be provided that is configured to recognize incorrectly aligned pieces of food 12a. In this case, only those pieces of food 12a can be contacted by the alignment elements 112a, 112b whose position on the punch 20 is outside an acceptable deviation. The pieces of food 12a are then transported, disposed on the punch surfaces 46, into a gripper cell 34.

A plurality of cutting grids 18 are provided in the gripper cell 34. As described above with reference to FIGS. 11 to 14, one of the drives 50 is arranged under each of the cutting grids. When the mover 22 loaded with the piece of food 12a has reached the cutting grids 18 and the punches 20 are thus arranged below the cutting grids 18, the mover 22 stops. The respective drive 50 then presses the respective punch 20 and the piece of food 12a disposed on the punch from bottom to top through the cutting grid 18 so that individual smaller pieces 12b are produced from the piece of food 12a. The gripper 14 is then moved over the smaller pieces 12b by means of the movement unit 16 and jointly grips the smaller pieces 12b. The gripper 14 is then moved to a further conveying device 84 on which packages 28, for example trays or L-boards, are arranged. The smaller pieces 12b are placed on these packages 28. The smaller pieces 12b are then further transported, disposed on the package 28, to a packaging machine.

After the smaller pieces 12b have been lifted from the punch surface 46 by the gripper 14, the respective punch 20 is moved back into its starting position again. The mover 22 can then move further along the transport path 26 to pick up pieces of food 12a again. In the present case, each mover 22 can be coupled to two punches 20. However, it would also be conceivable that the movers can only be coupled to one punch or to more than two punches.

In the left image half of FIG. 15, a mover 22 is shown without a punch, whereby the frame-shaped support structures 22b comprising the coupling devices 70 are visible that serve to hold the punch 20 in a vertically movable, but otherwise fixed manner, at the support structure 22b.

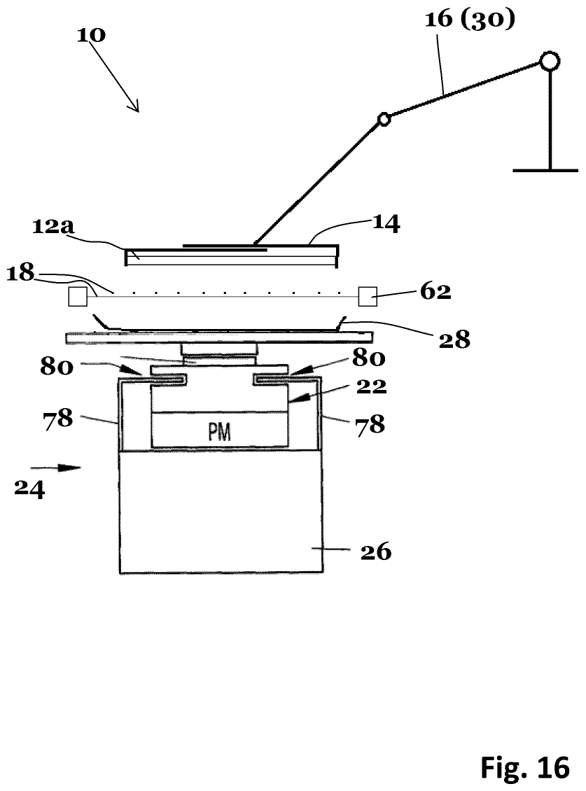

A further embodiment of an apparatus 10 for the automated cutting of a piece of food 12a into a plurality of smaller pieces 12b is shown in FIGS. 16 to 19B. In contrast to the embodiment shown in FIGS. 11 to 15, in the further embodiment now described, the piece of food 12a is cut by being pressed from top to bottom through a cutting grid 18.

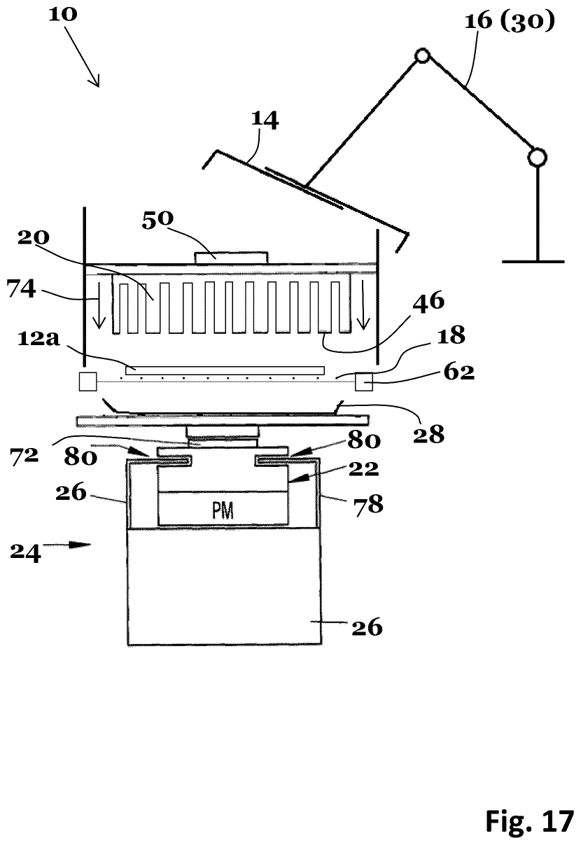

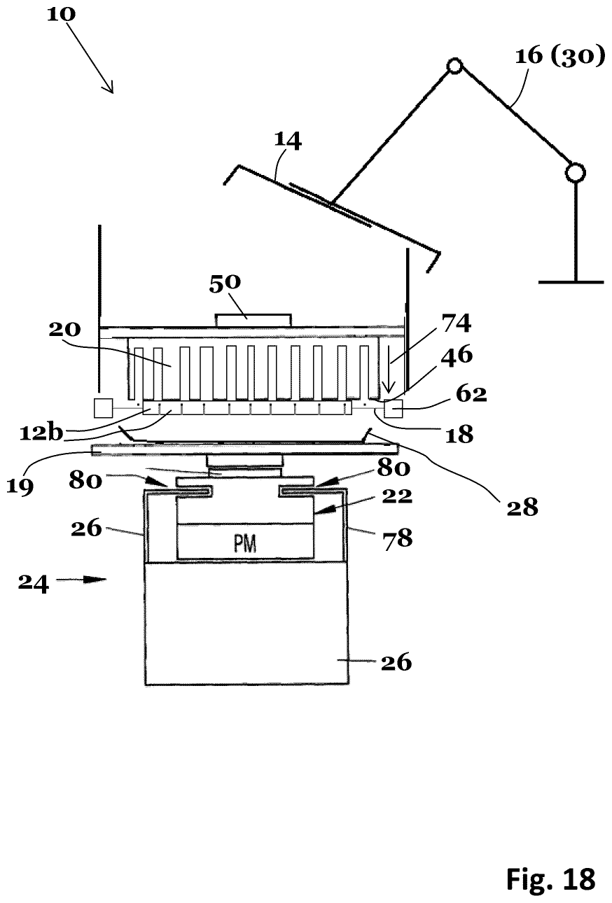

For this purpose, in a first step shown in FIG. 16, the piece of food 12a is placed onto an upper side of a cutting grid 18 by means of a gripper 14. In a second step shown in FIG. 17, a punch 20 is moved in the cutting direction 74 and in so doing is pressed from above onto the piece of food 12a. As a result, the piece of food 12a disposed on the upper side of the cutting grid 18 is pressed from above through the cutting grid 18 (see FIG. 18). When the piece of food has been pressed completely through the cutting grid 18, the plurality of smaller pieces 12b produced from the piece of food 12a can fall onto a package 28 arranged below the cutting grid. In this respect, the drop height should be as low as possible so that the plurality of smaller pieces 12b maintain their arrangement relative to one another, i.e. their grid arrangement.

In the present example, the package 28 is disposed on a support 19 of a mover 22. The mover 22 is part of a transport system 24 based on the so-called LSM drive described above. However, the package could also be placed on a conveyor belt, for example.

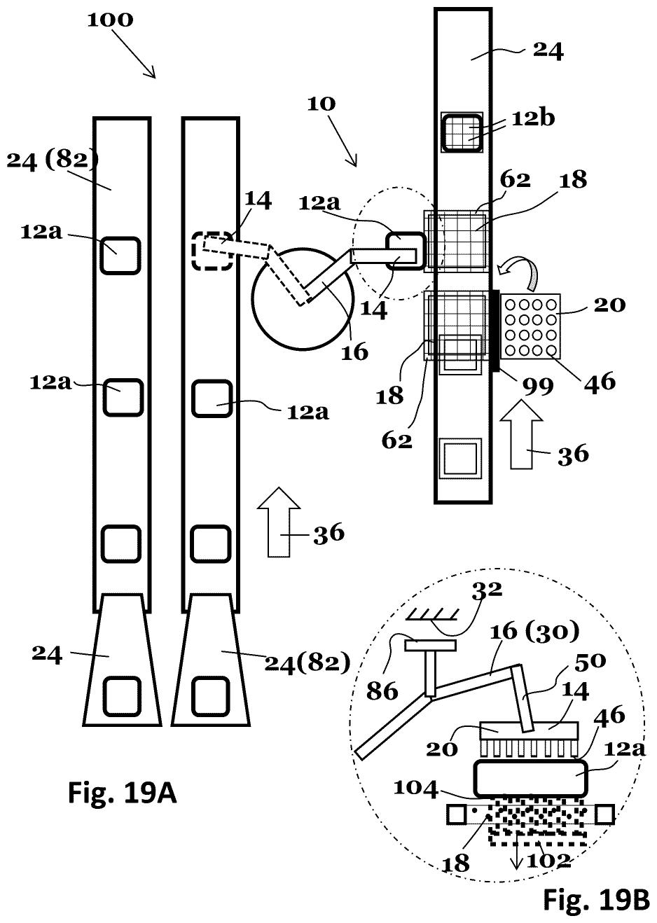

FIG. 19A shows a plan view of a part section of a food processing line 100 comprising the apparatus 10 in accordance with the second embodiment.

As in the first embodiment, pieces of food in the form of slices 12a are cut off from a block of food, for example a block of cheese, at a high-performance slicer, not shown. They are dispensed via a transport unit 24, for example a conveyor belt 82, to a further transport unit 24 that provides the pieces of food 12a for the gripper 14. In the present example, the gripper 14 is configured as a vacuum gripper 14b. However, the gripper 14 could also be configured as a mechanical gripper 14a.

The gripper 14 grips one of the provided pieces of food 12a and places it onto the upper side of one of the cutting grids 18. The punch 20 is then pressed from above against the piece of food 12a. With regard to the design of the drive for the punch 20, many possibilities are conceivable, of which two different ones are shown by way of example here. In FIG. 19A, a variant is shown in which the punch 20 is movably attached to a stationary support, a machine frame 99, and can be pivoted relative to this stationary support in order to press a piece of food 12a disposed on the cutting grid through the cutting grid 18. In FIG. 19B, a further variant is shown in which the punch 20 is arranged at the gripper 14, specifically in which the punch 20 and the gripper 14 represent a common component. In this variant, the force for cutting the piece of food 12a is applied by the movement unit 16 of the gripper 14, i.e. by a robot arm 30. In other words, the punch 20 is moved by a driving force applied by the robot arm 30. In order to keep the moments acting on the robot arm 30 small, a support apparatus 86 can be provided at the robot arm 30, by means of which support apparatus the robot arm 30 can be supported at a support surface 32, for example, a roof girder of a production hall.

FIG. 19B furthermore optionally shows a variant in which a structure 102 is provided that reaches from below through the cutting grid 18 and forms a support surface 104 on which the gripper 14 can place the piece of food 12a. This structure 102 can, for example, be movable downwards synchronously with the punch 20 and the piece of food 12a can be supported or lowered from below during the cutting process in order to place the piece of food 12a on the cutting grid 18.

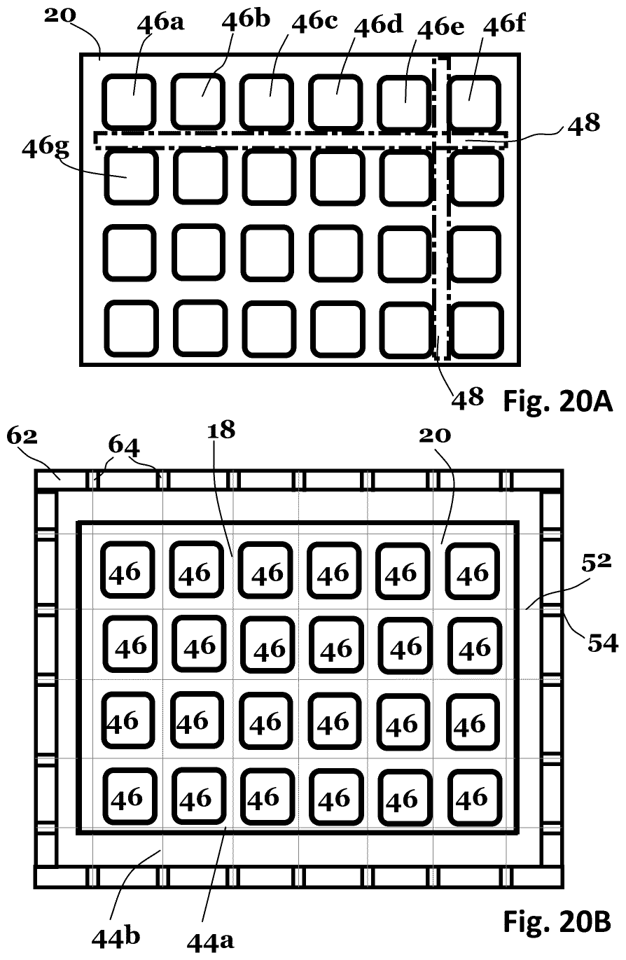

FIGS. 20A and 20B, on the one hand, and FIGS. 21A and 21B, on the other hand, show different variants of the design of the punch 20.

FIG. 20A shows a plan view of a punch surface 46, i.e. that surface of the punch 20 that comes into contact with the piece of food 12a during the cutting. The punch surface 46 is subdivided into a plurality of partial punch surfaces 46a-g etc. that are arranged in a matrix form in rows and columns. Grooves 48 are formed between the partial punch surfaces 46a-g. More precisely, the partial punch surfaces 46a-g etc. are delimited by two longitudinal grooves 48 and two transverse grooves 48. As can be seen in FIGS. 14 and 20B, the grooves 48 serve to receive the cutting grid 18 and thus prevent a collision between the punch 20 and the cutting grid 18. In FIGS. 20A and 10B, the partial punch surfaces 46a-g have a square periphery with rounded corners.

The variant shown in FIGS. 21A and 11B was developed to be able to clean the punch 20 more easily. Here, the partial punch surfaces 46a-g etc. have a corner-free, in particular circular, periphery.

Different variants of partial punches 118 forming partial punch surfaces 46 are shown in FIG. 25B. According to a first variant, the partial punch 118a can be solid. Alternatively thereto, the partial punch 118b, 118c can be hollow. At 118b, a partial punch with an outwardly open inner space or hollow space 120a is shown. At 118c, a partial punch with an inner space or hollow space 120b that is sealed off, i.e. that is defined at the peripheral side by the partial punch 118c, is shown.

FIGS. 20B and 21B show a variant in which the cutting grid 18 is formed from wires 52. Each wire forms either a longitudinal cutting edge 44a or a transverse cutting edge 44b. For this purpose, each of the wires 52 is clamped either in the longitudinal direction or in the transverse direction in a rectangular frame 62, also called a cutting frame. At the frame 62, grooves 64 are formed, in which a respective one of the wires 52 lies. The grooves 64 are adapted to the thickness of the wire 52 in terms of their width and serve to laterally guide the wires 52. The cutting accuracy is hereby improved.

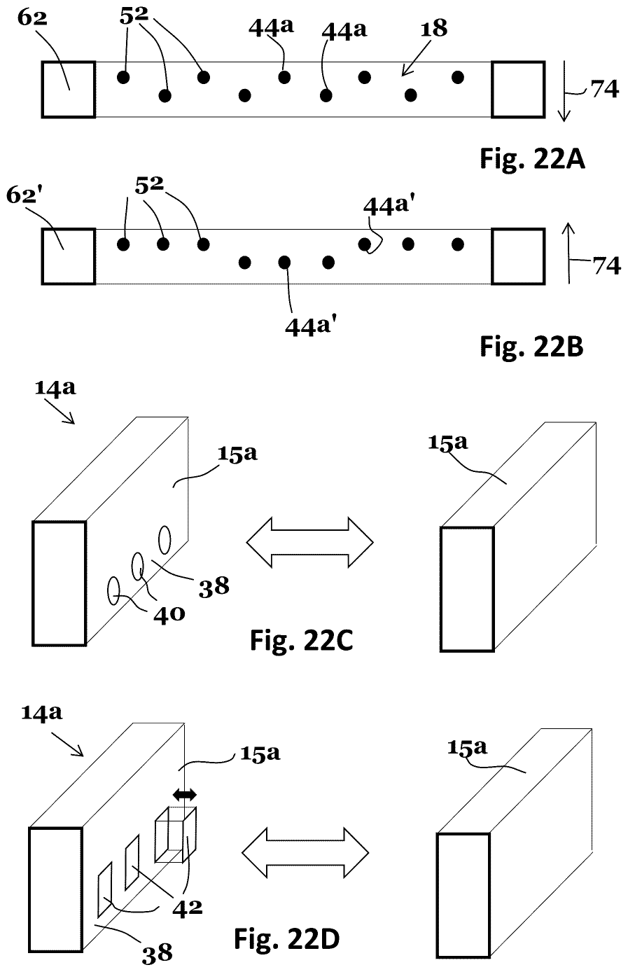

FIGS. 22A and 22B show variants of the cutting grid 18 in which the longitudinal cutting edges 44a are arranged on different planes in order to reduce a maximum required feed force for the punch 20 in that the piece of food 12a first comes into contact with a first group of cutting edges 44a and only then comes into contact with a second group of cutting edges 44a when the first group of cutting edges 44a has already dipped into the piece of food 12a. Alternatively or additionally, it would be conceivable to arrange the transverse cutting edges 44b spaced apart from one another in the cutting direction 74.

Variants of release aids that serve to prevent food 12 from adhering to gripping elements 15a of mechanical grippers 14a are shown in FIGS. 22C and 22D. In FIG. 22C, a variant is shown in which the gripping elements 15a have outlet openings 40 in holding surfaces 38 that can be brought into contact with the food 12. The outlet openings 40 are connected to channels that can be supplied with compressed air by the apparatus 10. A compressive force can hereby be applied to the food 12 in order to release the food 12 from the respective gripping element 15a.

In FIG. 22D, a variant of a mechanical gripper 14a is shown in which release punches 42 are provided in the holding surface 38. Said release punches 42 can be moved out of the holding surface 38 to reduce a contact surface between the food 12 and the gripping element 15a, and thus to release the food 12 from the gripping element 15a. As a rule, such a release aid is not necessary for vacuum grippers. However, for the processing of sticky food products, it would also be conceivable to provide a release aid for vacuum grippers, for example by generating an excess pressure in the vacuum channels.

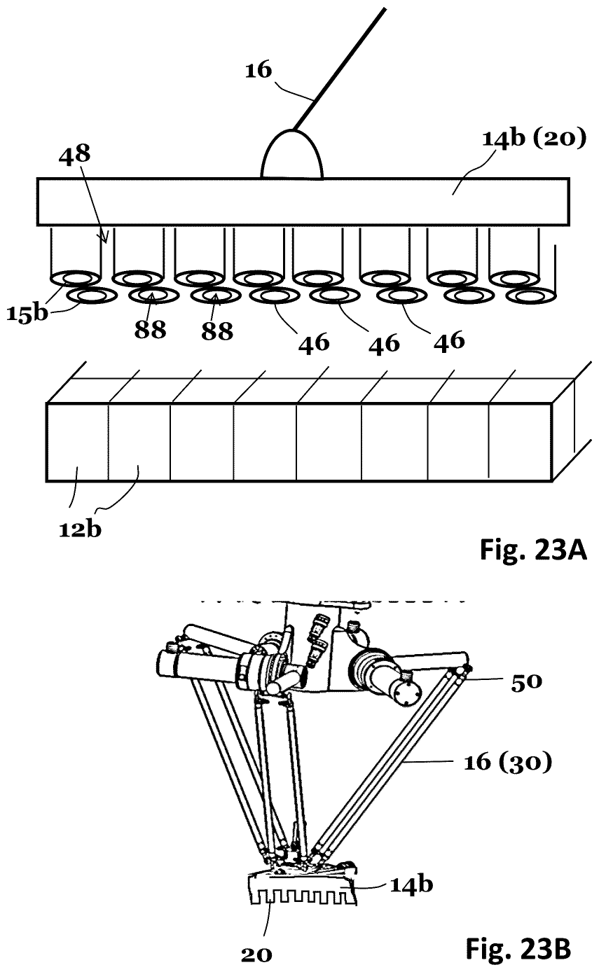

FIGS. 23A and 23B show an embodiment possibility of the gripper 14 as a vacuum gripper 14b. The vacuum gripper 14b has a plurality of suction elements 15b that are arranged in rows and columns and that are configured to suck in and hold a respective one of the pieces 12b. The suction elements 15b have, at the end face, suction openings 88 by means of which a suction force can be applied to the pieces 12b. To be able to place the smaller pieces 12b spaced apart from one another, the suction elements 15b can be configured as adjustable with respect to their distance from one another. For example, setting motors can be provided to adjust the suction elements 15b relative to one another.

To also be able to use the vacuum gripper 14b as the punch 20, grooves 48, into the cutting grid 18 can dip, are provided between the suction elements 15b. In addition, border surfaces of the suction openings 88 serve as punch surfaces 46. Thus, the vacuum gripper 14b can be used as the punch 20.

FIG. 23B shows a possible embodiment for the movement unit 16. The movement unit 16 comprises arms of a delta robot. However, the movement unit 16 can take on any possible shape that allows the gripper 14 to be moved back and forth between its different positions.

FIGS. 24A and 24B show two variants of how wires 52 forming cutting grids 18 can be designed as flexible. For this purpose, the wires 52 of the cutting grid 18 are connected at two oppositely disposed sides to a suspension 54, for example, a frame 62. At least one of the suspensions 54 can yield when the wire 52 is loaded by the food product 12. For this purpose, the suspension 54 has a movably guided part 54a to which the wire 52 is fixed. The movably guided part 54a is connected to an immovable part 54b of the suspension 54 via a spring 56. On a movement 92 of the movable part 54a relative to the immovable part 54b, the spring 56 generates a return force 90 on the movable part 54a of the suspension 54.

FIG. 24B shows a second variant of how the wires 52 forming the cutting grid 18 can be designed as flexible. Instead of a classic mechanical spring, a pneumatic element 58 is used in this variant to produce the flexibility of the suspension 54. In this variant, the wire 52 is coupled to a piston 92. When the wire 52 is loaded by the piece of food 12a, the piston 92 of the pneumatic element 58 yields, i.e. it moves in the direction of the wire 52. Air is hereby compressed in a cylinder 96 of the pneumatic element 58, whereby a counterforce acts on the piston 92. Due to setting devices 60 in the form of a pump, a basic pressure, and thus a clamping force, on the wire 52 can be increased or decreased. The tension force applied to the wire 52 can be controlled by a pressure sensor 66 in the interior of the cylinder 96. Furthermore, it could also be determined by the pressure sensor 66 whether the wire 52 is torn. This would be the case if the pressure in cylinder 96 falls below a threshold value. Alternatively thereto, separate devices 68 for recognizing damage to the respective wire 52 can be provided. For this purpose, the cylinder 96 can have an outlet opening 98 that is released when the piston 92 is pressed against an end face 92a remote from the wire by the pressure in the cylinder 96. When an airflow through the outlet opening 98 is recognized by the devices 68 for recognizing damage to the respective wire 52, a signal can be output that the wire 52 is torn.

FIG. 25A shows a possible embodiment of a receiver 114 for the frame or cutting frame 62. The receiver 114 serves to hold the frame 62 securely and in a defined manner during operation. For this purpose, the receiver 114 defines a support plane 124 which is preferably oriented horizontally during operation and on which the frame 62 can be placed. The receiver 114 is designed such that the frame 62 can be removed from the receiver 114, for example, to be replaced with another frame 62. For this purpose, holding devices 122 that are adjustable, for example pivotable, displaceable and/or movable by a screwing movement, are provided at the receiver 114 and can be adjusted between a holding position (see holding devices 122 at the left) and a release position (see holding devices 122 at the right) in order to selectively fix the frame 62 or release the frame 62. In order to make an adjustment of the holding devices 122 as simple as possible, the holding devices 122 can be adjustable and/or lockable without tools. So that a user of the apparatus 10 can gain access to the frame 62 more easily, the receiver 114 is preferably pivotably supported about a pivot axis 110. The pivot axis 110 can extend in a horizontal direction, as shown in FIG. 25A. Alternatively thereto, the pivot axis 110 can extend in a vertical direction, for example.

### REFERENCE NUMERAL LIST

10 apparatus
12 food
12a piece of food
12b pieces
14 gripper
14a mechanical gripper
14b vacuum gripper
15a gripping element
15b suction element
16 movement unit
18 cutting unit
18a outer contour mold
18b inner contour mold
19 support
20 punch
20a flexible section
20b spring element
20c outer contour
20d inner contour
21 undercut
22 mover
22a runner
22b support structure
24 transport system
26 transport path
27 guide
28 package
30 robot arm
32 support surface
34 gripper cell
36 conveying direction
38 holding surface
40 outlet opening
42 release punch
44 cutting edge
44a longitudinal cutting edge
44b transverse cutting edge
46 punch surface
46a-g partial punch surfaces
47 periphery
48 groove (punch)
49 webs
50 drive (punch)
50a drive element
52 wire
54 suspension
54a movable part
54b immovable part
56 spring element
58 pneumatic element
60 setting devices
62 frame
64 groove (frame)
66 force regulation devices
68 devices for recognizing damage
70 coupling devices
72 fixing device
74 cutting direction
76 lifting rail
78 guide rail
80 slots
82 conveyor belt
84 conveying device
86 support apparatus
88 suction opening
90 return force
92 piston
92a end face
94 counterforce
96 cylinder
98 outlet opening
99 machine frame
100 food processing line
102 structure
104 support surface
106 centering devices
108 centering devices
110 pivot axis
112 alignment unit
112a alignment element
112b alignment element
113 detection device
114 receiver
116 recess
118 partial punch
120 inner space
122 holding devices
124 recess
126 scraping device
126a scraping element
126b spring element (scraping device)
128 flexible section
PM permanent magnet

1. A method for cutting at least one piece of food into a plurality of smaller pieces, the method comprising:
providing the at least one piece of food on a support structure arranged below a cutting unit,
moving a punch relative to the support structure to lift the at least one piece of food from the support structure,
moving the punch relative to the cutting unit and/or moving the cutting unit relative to the punch so that the at least one piece of food is pressed from below through the cutting unit and the at least one piece of food is thereby cut into smaller pieces, and
lifting the plurality of smaller pieces or at least one of the smaller pieces using a gripper.

2. A method according to claim 1,
wherein the support structure is coupled or can be coupled to a mover of a transport system, and
wherein providing the at least one piece of food comprises transporting the at least one piece of food disposed on the support structure by the transport system under the cutting unit.

3. A method according to claim 1,
wherein the support structure is coupled or can be coupled to a mover of a transport system, and
wherein providing the at least one piece of food comprises transporting the at least one piece of food disposed on the support structure by the transport system over the punch.

4. A method according to claim 2,
wherein a plurality of support structures and a plurality of movers are provided, and
wherein at least one of the plurality of support structures is coupled or can be coupled to one of the plurality of movers of the transport system in each case, and a plurality of pieces of food are provided in that the plurality of pieces of food are successively transported individually disposed on one of the plurality of support structures by the transport system under the cutting unit.

5. A method according to claim 1,
wherein the moving of the punch relative to the support structure to lift the at least one piece of food from the support structure comprises an engagement of the punch into at least one recess of the support structure.

6. A method according to claim 1,
wherein the lifting of the plurality of smaller pieces or of the at least one of the smaller pieces is carried out using a mechanical gripper.

7. (canceled)

8. A method according to claim 1,
wherein the gripper places or drops the plurality of smaller pieces or the at least one of the smaller pieces onto or into a package.

9. A method according to claim 1, further comprising:
providing a scraping device,
wherein the scraping device scrapes off at least a partial quantity of the plurality of smaller pieces from the cutting unit.

10. A method according to claim 1,
wherein the punch is attached in a stationary manner to a machine frame and, during movement of the punch relative to the support structure, the punch is moved exclusively in a cutting direction and against the cutting direction.

11. A method for cutting at least one piece of food into a plurality of smaller pieces, the method comprising:
placing or dropping the at least one piece of food using a gripper onto an upper side of a cutting unit or an upper side of a structure movable through the cutting unit, and
moving a punch relative to the cutting unit and/or moving the cutting unit relative to the punch so that the at least one piece of food is pressed from above through the cutting unit and the at least one piece of food is thereby cut into the plurality of smaller pieces.

12. A method according to claim 11,
wherein the placing or dropping of the at least one piece of food is carried out using a mechanical gripper or a vacuum gripper.

13. (canceled)

14. A method according to claim 10,
wherein the at least one piece of food comprises a food slice cut off from a food bar using a slicer.

15. A method according to claim 10,
wherein a plurality of cutting units is provided per gripper, and wherein the method further comprises:
moving a first punch relative to a first cutting unit and/or moving the first cutting unit relative to the first punch to cut a first piece of food into first smaller pieces, and
parallel to moving the first punch and/or the first cutting unit:
moving a second punch relative to a second cutting unit and/or moving the second cutting unit relative to the second punch to cut a second piece of food into second smaller pieces.

16. (canceled)

17. An apparatus for cutting at least one piece of food into a plurality of smaller pieces, the apparatus comprising:
at least one cutting unit,
at least one punch to press the at least one piece of food through the at least one cutting unit, and
at least one gripper,
wherein the at least one gripper can be moved into a region above the at least one cutting unit to:
place the at least one piece of food on an upper side of the at least one cutting unit or a support surface movable through the at least one cutting unit, or
pick up the plurality of smaller pieces or at least one of the plurality of smaller pieces from the upper side of the at least one cutting unit or the support surface movable through the at least one cutting unit.

18. An apparatus according to claim 17,
wherein the support surface represents a surface, of the at least one punch.

19. An apparatus according to claim 17,
wherein the at least one gripper is configured as a mechanical gripper and/or as a vacuum gripper, and/or
wherein the at least one gripper is coupled to a robot arm and the at least one gripper can be moved into the region above the at least one cutting unit by the robot arm.

20. An apparatus according to claim 19,
wherein the at least one gripper has at least one holding surface and wherein at least one outlet opening that can be flowed through by gas is formed in the at least one holding surface in order to release a food adhering to the at least one holding surface from the at least one holding surface by compressed air or gas, and/or
wherein the at least one gripper comprises at least one release punch that can be moved out of the at least one holding surface in order to release a food adhering to the at least one holding surface from the at least one holding surface.

21. An apparatus according to claim 17,
wherein the apparatus comprises a scraping device to scrape off at least a partial quantity of the plurality of smaller pieces from the at least one cutting unit.

22. (canceled)

23. An apparatus according to claim 17,
wherein the at least one punch has a punch surface, and wherein grooves corresponding to the at least one cutting unit are provided in the punch surface, into which grooves the at least one cutting unit dips when the at least one piece of food has been pressed through the at least one cutting unit, and
wherein the punch surface forms a plurality of partial punch surfaces surrounded by the grooves, and
wherein at least some of the plurality of partial punch surfaces have corner-free periphery, and/or
wherein at least some partial punches of the at least one punch forming the plurality of partial punch surfaces are hollow.

24. (canceled)

25. An apparatus according to claim 17,
wherein the at least one punch is coupled or can be coupled to a drive to move the at least one punch in order to press the at least one piece of food through the at least one cutting unit, and
wherein the drive is configured as a servomotor or as a pneumatic drive.

26. (canceled)

27. An apparatus according to claim 17,
wherein the at least one cutting unit has a plurality of cutting edges-arranged spaced apart from one another in a direction of movement of the at least one punch.

28. An apparatus according to claim 17,
wherein the at least one cutting unit is configured as a cutting grid, wherein the cutting grid is configured as a wire grid having a plurality of wires.

29-33. (canceled)

34. An apparatus according to claim 17,
wherein the at least one cutting unit is configured as at least one cutting mold, wherein the at least one cutting mold comprises a plurality of cutting blades.

35. (canceled)

36. An apparatus according to claim 17,
wherein a support structure is coupled or can be coupled to a mover of a transport system and the transport system is configured to transport the at least one piece of food disposed on the support structure under the at least one cutting unit and/or over the at least one punch, and
wherein the at least one punch is movable in a vertical direction relative to the support structure in order to lift the at least one piece of food from the support structure and to press it through the at least one cutting unit.

37-39. (canceled)

40. An apparatus according to claim 17,
wherein the apparatus comprises an alignment unit to align the at least one piece of food to be cut with the at least one cutting unit.

41. A food processing line comprising at least one of a slicer, a sorting and conveying path, or a packaging machine; and
an apparatus for cutting at least one piece of food-into a plurality of smaller pieces, comprising:
at least one cutting unit
at least one punch to press the at least one piece of food through the at least one cutting unit, and
at least one gripper
wherein the at least one gripper can be moved into a region above the at least one cutting unit to:
place the at least one piece of food on an upper side of the at least one cutting unit or a support surface movable through the at least one cutting unit. or
pick up the plurality of smaller pieces or at least one of the plurality of smaller pieces from the upper side of the at least one cutting unit or the support surface movable through the at least one cutting unit.

42-73. (canceled)
